(19) United States
(12) Patent Application Publication
(10) Pub. No.: US 2024/0155041 A1
(43) Pub. Date: May 9, 2024

(54) Message Handling in a Fifth Generation Network

(71) Applicant: Telefonaktiebolaget LM Ericsson(publ), Stockholm (SE)

(72) Inventors: Maria Cruz Bartolome Rodrigo, Madrid (ES); Aldo Bolle, Västra Frölunda (SE)

(21) Appl. No.: 18/550,600

(22) PCT Filed: Apr. 13, 2022
(86) PCT No.: PCT/EP2022/059926

§ 371 Date: Sep. 14, 2023

(30) Foreign Application Priority Data
Apr. 14, 2021 (EP) 21382316.4
Apr. 14, 2021 (EP) 21382317.2

(51) Int. Cl. H04L 67/51; H04W 4/20; H04W 28/08; H04W 28/084

(52) U.S. Cl. CPC H04L 67/51; H04W 4/20; H04W 28/084; H04W 28/0992

(57) ABSTRACT

There is provided a method for a fifth generation network. The method is performed by a first network function (NF) node of a service consumer or a first service communication proxy (SCP) node that is configured to operate as an SCP between the first NF node and one or more second NF nodes of a service producer. A message is received (102) from a second network node. The message comprises an indication that a second NF node is under testing in the network. The indication signals that the second NF node is a candidate for selection when selecting at least one second NF node towards which network traffic is to be transmitted, and/or the message comprises load information for the second NF node and the indication signals that the load information is representative of a predefined amount of network traffic that the second NF node is required to receive.

### TECHNICAL FIELD

The disclosure relates to methods for handling messages in a fifth generation network, and nodes configured to operate in accordance with those methods.

### BACKGROUND

There exist various techniques for handling a request for a service in a network. A service request is generally from a consumer of the service (“service consumer”) to a producer of the service (“service producer”). For example, a service request may be from a network function (NF) node of a service consumer to an NF node of a service producer. The NF node of the service consumer and the NF node of the service producer can communicate directly or indirectly. This is referred to as direct communication and indirect communication respectively. In the case of indirect communication, the NF node of the service consumer and the NF node of the service producer may communicate via a service communication proxy (SCP) node.

FIG. 1A-D illustrates different existing systems for handling service requests, as set out in 3GPP TS 23.501 v16.4.0. In more detail, FIGS. 1A and 1B illustrate systems that use direct communication, while FIGS. 1C and 1D illustrate systems that use indirect communication.

In the systems illustrated in FIGS. 1A and 1B, a service request is sent directly from the NF node of the service consumer to the NF node of the service producer. A response to the service request is sent directly from the NF node of the service producer to the NF node of the service consumer. Similarly, any subsequent service requests are sent directly from the NF node of the service consumer to the NF node of the service producer. The system illustrated in FIG. 1B also comprises a network repository function (NRF) node. Thus, in the system illustrated in FIG. 1B, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In the system illustrated in FIG. 1A, the NRF node is not used and instead the NF node of the service consumer may be configured with the NF profile(s) of the NF node(s) of the service producer.

In the systems illustrated in FIGS. 1C and 1D, a service request is sent indirectly from the NF node of the service consumer to the NF node of the service producer via a service communication proxy (SCP) node. A response to the service request is sent indirectly from the NF node of the service producer to the NF node of the service consumer via the SCP node. Similarly, any subsequent service requests are sent indirectly from the NF node of the service consumer to the NF node of the service producer via the SCP node. The systems illustrated in FIGS. 10 and D also comprise an NRF node.

In the system illustrated in FIG. 10, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In this case, the service request sent from the NF node of the service consumer to the SCP node comprises the address of the selected NF node of the service producer. The NF node of the service consumer can forward the service request without performing any further discovery or selection. In case the selected NF node of the service producer is not accessible for any reason, it may be up to the NF node of the service consumer to find an alternative. In other cases, the SCP node may communicate with the NRF node to acquire selection parameters (e.g. location, capacity, etc.) and the SCP node may select an NF node of the service producer to which to send the service request.

In the system illustrated in FIG. 1D, the NF node of the service consumer does not carry out the discovery or selection process. Instead, the NF node of the service consumer adds any necessary discovery and selection parameters (required to find a suitable NF node of the service producer) to the service request that it sends via the SCP node. The SCP node uses the request address and the discovery and selection parameters in the service request to route the service request to a suitable NF node of the service producer. The SCP node can perform discovery with the NRF node.

For the fifth generation core (5GC), from Release 16, the SCP node is included as a network element to allow indirect communication between an NF node of a service consumer and an NF node of a service producer. The indirect communication that is used can be either of the two indirect communications options described earlier with reference to FIGS. 1C and 1D.

According to the above-described systems, the NF node of the service consumer or the SCP node needs to initially select (or reselect, e.g. in case of a failure) an NF node of a service producer, such as among a plurality of functionally equivalent instances of the NF node of the service producer. Generally, this selection (or reselection) is based on one or more characteristics (or properties) of the NF nodes of the service producer, such as those defined in the profiles of the NF nodes of the service producer. Examples of the characteristics include a priority assigned to the NF nodes of the service producer, a locality of the NF nodes of the service producer, a capacity of the NF nodes of the service producer, and a load on the NF nodes of the service producer. In some situations, the selection (or reselection) may take into account other information from an NF node of the service producer, such as load information received in responses from the NF node of the service producer, and/or any configured policies, such as which locality is to take precedence over another.

3GPP TS 29.500 v17.1.0 defines two load control mechanisms. The first load control mechanism relies on the NF node of the service producer updating the load information in its profile that is stored at the NRF node, and then the NF node of the service consumer or the SCP node can discover this NF profile that comprises the load information. The second load control mechanism relies on the NF node of the service producer signalling the load information to the NF node of the service consumer or the SCP node. Generally, the load information in both mechanisms includes a value from 0 (minimum) to 100 (maximum), which provides an indication of the resource usage at the NF node of the service producer. For example, if the load information for an NF node of a service producer comprises a value of 100, the NF node of the service consumer or the SCP node interprets this as indicating that no new requests are to be transmitted towards the NF node of a service producer. On the other hand, if the load information for an NF node of a service producer comprises a value of 0, the NF node of the service consumer or the SCP node interprets this as indicating that the NF node of the service producer is not processing any network traffic (i.e. there is no load on the NF node of the service producer). Then, based on the load information, the NF node of the service consumer or the SCP node is able to select the less loaded target.

### SUMMARY

In a network, there may be a need to introduce new resources and/or new upgrades (e.g. features). For example, there may be some situations in which a customer may request this. However, this currently requires specific implementation and/or configuration in the NF node of the service consumer or the SCP node and there is currently no mechanism defined in the art to support this.

In the 5GC, it is defined that an application programming interface version (api-version) may be included in a profile of an NF node of a service producer. With this api-version, an NF node of a service consumer may select only an instance of an NF node with this specific api-version. In some cases, a new api-version or even a dummy api-version can be defined for testing purposes. However, the use of the api-version when including upgraded software (e.g. to be tested prior to final introduction in the network) requires that an NF node of a service consumer must elect a specific api-version (e.g. api-versionX). As such, specific logic is required in the NF node of the service consumer. This can be problematic as it may only be possible to include specific logic for instances of the same vendor or based on integration projects.

It is an object of the disclosure to obviate or eliminate at least some of the above-described disadvantages associated with existing techniques.

Therefore, according to an aspect of the disclosure, there is provided a method for handling messages in a fifth generation network. The method is performed by a first network node. The first network node is a first network function (NF) node of a service consumer or a first service communication proxy (SCP) node that is configured to operate as an SCP between the first NF node and one or more second NF nodes of a service producer. The method comprises receiving a message from a second network node. The message comprises an indication that a second NF node of the one or more second NF nodes is under testing in the network. The indication signals to the first network node that the second NF node a candidate for selection when selecting at least one second NF node of the one or more second NF nodes towards which network traffic is to be transmitted, and/or the message comprises load information for the second NF node and the indication signals to the first network node that the load information is representative of a predefined amount of network traffic that the second NF node is required to receive.

According to another aspect of the disclosure, there is also provided a first network node comprising processing circuitry configured to operate in accordance with this method described in respect of the first network node. In some embodiments, the first network node may comprise at least one memory for storing instructions which, when executed by the processing circuitry, cause the first network node to operate in accordance with this method described in respect of the first network node.

According to another aspect of the disclosure, there is also provided another method for handling messages in a fifth generation network. The method is performed by a second network node. The method comprises initiating transmission of a message towards a first network node. The first network node is a first network function (NF) node of a service consumer or a first service communication proxy (SCP) node that is configured to operate as an SCP between the first NF node and one or more second NF nodes of a service producer. The message comprises an indication that a second NF node of the one or more second NF nodes is under testing in the network. The indication signals to the first network node that the second NF node is a candidate for selection when selecting at least one second NF node of the one or more second NF nodes towards which network traffic is to be transmitted, and/or the message comprises load information for the second NF node and the indication signals to the first network node that the load information is representative of a predefined amount of network traffic that the second NF node is required to receive.

According to another aspect of the disclosure, there is provided a second network node comprising processing circuitry configured to operate in accordance with this method described in respect of the second network node. In some embodiments, the second network node may comprise at least one memory for storing instructions which, when executed by the processing circuitry, cause the second network node to operate in accordance with this method described in respect of the second network node.

According to another aspect of the disclosure, there is provided a method performed by a system. The method comprises the method described in respect of the first network node and the method described in respect of the second network node.

According to another aspect of the disclosure, there is provided a system comprising at least one first network node as described earlier and at least one second network node as described earlier.

According to another aspect of the disclosure, there is provided a computer program comprising instructions which, when executed by processing circuitry, cause the processing circuitry to perform the method described in respect of the first network node and/or the method described in respect of the second network node.

According to another aspect of the disclosure, there is provided a computer program product, embodied on a non-transitory machine-readable medium, comprising instructions which are executable by processing circuitry to cause the processing circuitry to perform the method described in respect of the first network node and/or the method described in respect of the second network node.

Therefore, an improved technique for handling messages in a fifth generation network is provided.

### BRIEF DESCRIPTION OF THE DRAWINGS

For a better understanding of the techniques, and to show how they may be put into effect, reference will now be made, by way of example, to the accompanying drawings, in which:

FIG. 1A-D is a block diagram illustrating different existing systems;

FIG. 2 is a block diagram illustrating a second network node according to an embodiment;

FIG. 3 is a block diagram illustrating a method performed by a second network node according to an embodiment;

FIG. 4 is a block diagram illustrating a first network node according to an embodiment;

FIG. 5 is a block diagram illustrating a method performed by a first network node according to an embodiment;

FIG. 6 is a signalling diagram illustrating an exchange of signals in a system according to an embodiment;

FIG. 7 is a signalling diagram illustrating an exchange of signals in a system according to an embodiment; and

FIG. 8 is a signalling diagram illustrating an exchange of signals in a system according to an embodiment.

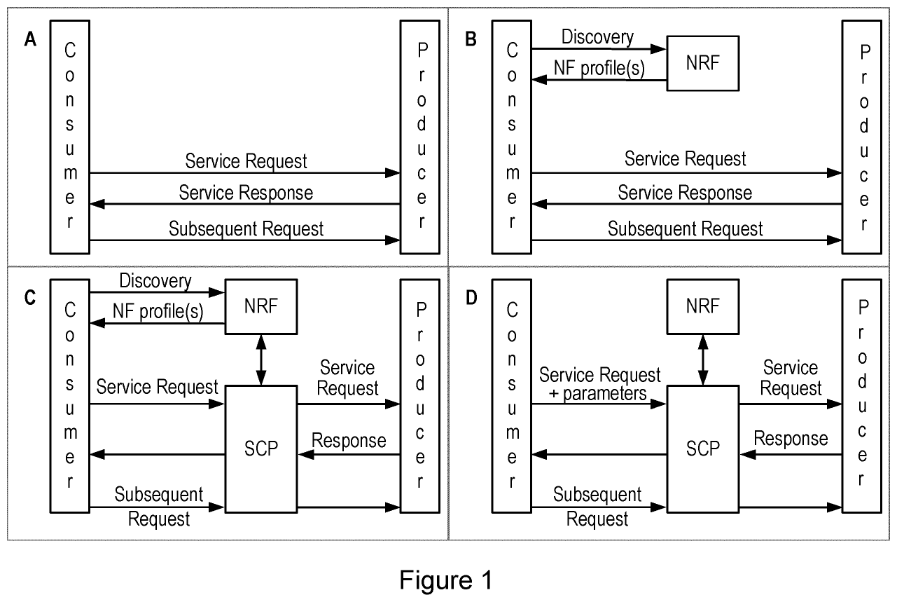

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, there is described herein advantageous techniques for handling messages in a fifth generation network. The techniques described herein can be used in respect of any fifth generation (5G) network, such as any 5G communications or telecommunications network, e.g. cellular network. In some embodiments, the network may be a core network or a radio access network (RAN). The techniques described herein are implemented by a first network node and a second network node. The first network node is a first network function (NF) node of a service consumer or a first service communication proxy (SCP) node that is configured to operate as an SCP between the first NF node and one or more second NF nodes of a service producer. The second network node is a second NF node of a service producer or a network repository function (NRF) node.

Although the techniques are described herein in relation to one or more NF nodes of one or more service consumers and one or more NF nodes of one or more servicer producers, it will be understood that an NF node may act (e.g. operate) as an NF node of a service consumer and/or as an NF node of a service producer.

An NF is a third generation partnership project (3GPP) adopted, or 3GPP defined, processing function in a network, which has defined functional behaviour and 3GPP defined interfaces. An NF can be implemented either as a network element on a dedicated hardware, as a software instance running on a dedicated hardware, or as a virtualised function instantiated on an appropriate platform, e.g. on a cloud infrastructure. Herein, the term “node” in relation to an “NF node” will be understood to cover each of these scenarios. Herein, references to a plurality of NF nodes of a service producer may refer to, for example, functionally equivalent instances of NF nodes of the service producer.

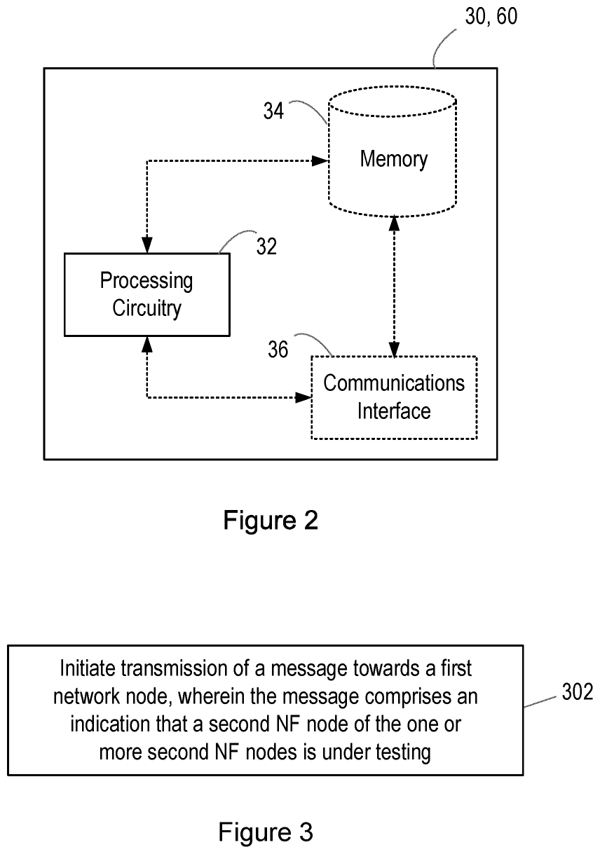

FIG. 2 illustrates a second network node 30, 60 in accordance with an embodiment. The second network node 30, 60 is for handling messages in a fifth generation network. In some embodiments, the second network node 30, 60 can, for example, be a physical machine (e.g. a server) or a virtual machine (VM). The second network node 30, 60 can be a second NF node 30 of a service producer or an NRF node 60.

As illustrated in FIG. 2, the second network node 30, 60 comprises processing circuitry (or logic) 32. The processing circuitry 32 controls the operation of the second network node 30, 60 and can implement the method described herein in respect of the second network node 30, 60. The processing circuitry 32 can be configured or programmed to control the second network node 30, 60 in the manner described herein. The processing circuitry 32 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the second network node 30, 60. In some embodiments, the processing circuitry 32 can be configured to run software to perform the method described herein in respect of the second network node 30, 60. The software may be containerised according to some embodiments. Thus, in some embodiments, the processing circuitry 32 may be configured to run a container to perform the method described herein in respect of the second network node 30, 60.

Briefly, the processing circuitry 32 of the second network node 30, 60 is configured to initiate transmission of a message towards a first network node. The first network node is a first NF node of a service consumer or a first SCP node that is configured to operate as an SCP between the first NF node and one or more second NF nodes of a service producer. The message comprises an indication that a second NF node of the one or more second NF nodes is under testing in the network. The indication signals to the first network node that the second NF node is a candidate for selection when selecting at least one second NF node of the one or more second NF nodes towards which network traffic is to be transmitted, and/or the message comprises load information for the second NF node and the indication signals to the first network node that the load information is representative of a predefined amount of network traffic that the second NF node is required to receive.

As illustrated in FIG. 2, in some embodiments, the second network node 30, 60 may optionally comprise a memory 34. The memory 34 of the second network node 30, 60 can comprise a volatile memory or a non-volatile memory. In some embodiments, the memory 34 of the second network node 30, 60 may comprise a non-transitory media. Examples of the memory 34 of the second network node 30, 60 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 32 of the second network node 30, 60 can be communicatively coupled (e.g. connected) to the memory 34 of the second network node 30, 60. In some embodiments, the memory 34 of the second network node 30, 60 may be for storing program code or instructions which, when executed by the processing circuitry 32 of the second network node 30, 60, cause the second network node 30, 60 to operate in the manner described herein in respect of the second network node 30, 60. For example, in some embodiments, the memory 34 of the second network node 30, 60 may be configured to store program code or instructions that can be executed by the processing circuitry 32 of the second network node 30, 60 to cause the second network node 30, 60 to operate in accordance with the method described herein in respect of the second network node 30, 60. Alternatively or in addition, the memory 34 of the second network node 30, 60 can be configured to store any information, data, messages, requests, responses, indications, notifications, signals, or similar, that are described herein. The processing circuitry 32 of the second network node 30, 60 may be configured to control the memory 34 of the second network node 30, 60 to store information, data, messages, requests, responses, indications, notifications, signals, or similar, that are described herein.

In some embodiments, as illustrated in FIG. 2, the second network node 30, 60 may optionally comprise a communications interface 36. The communications interface 36 of the second network node 30, 60 can be communicatively coupled (e.g. connected) to the processing circuitry 32 of the second network node 30, 60 and/or the memory 34 of the second network node 30, 60. The communications interface 36 of the second network node 30, 60 may be operable to allow the processing circuitry 32 of the second network node 30, 60 to communicate with the memory 34 of the second network node 30, 60 and/or vice versa. Similarly, the communications interface 36 of the second network node 30, 60 may be operable to allow the processing circuitry 32 of the second network node 30, 60 to communicate with the first network node and/or any other node mentioned herein. The communications interface 36 of the second network node 30, 60 can be configured to transmit and/or receive information, data, messages, requests, responses, indications, notifications, signals, or similar, that are described herein. In some embodiments, the processing circuitry 32 of the second network node 30, 60 may be configured to control the communications interface 36 of the second network node 30, 60 to transmit and/or receive information, data, messages, requests, responses, indications, notifications, signals, or similar, that are described herein.

Although the second network node 30, 60 is illustrated in FIG. 2 as comprising a single memory 34, it will be appreciated that the second network node 30, 60 may comprise at least one memory (i.e. a single memory or a plurality of memories) 34 that operates in the manner described herein. Similarly, although the second network node 30, 60 is illustrated in FIG. 2 as comprising a single communications interface 36, it will be appreciated that the second network node 30, 60 may comprise at least one communications interface (i.e. a single communications interface or a plurality of communications interface) 36 that operates in the manner described herein. It will also be appreciated that FIG. 2 only shows the components required to illustrate an embodiment of the second network node 30, 60 and, in practical implementations, the second network node 30, 60 may comprise additional or alternative components to those shown.

FIG. 3 illustrates a method performed by a second network node 30, 60 in accordance with an embodiment. The method is for handling messages in a fifth generation network. The second network node 30, 60 described earlier with reference to FIG. 2 can be configured to operate in accordance with the method of FIG. 3. In some embodiments, the method can be performed by or under the control of the processing circuitry 32 of the second network node 30, 60. As mentioned earlier, the second network node can be a second NF node of a service producer or an NRF node.

As illustrated at block 302 of FIG. 3, transmission of a message is initiated towards a first network node. As mentioned earlier, the first network node is a first NF node of a service consumer or a first SCP node that is configured to operate as an SCP between the first NF node and one or more second NF nodes of a service producer. Herein, the term “initiate” can mean, for example, cause or establish. Thus, the second network node 30, 60 (e.g. the processing circuitry 32 of the second network node 30, 60) can be configured to itself transmit the message or can be configured to cause another node to transmit the message (e.g. via a communications interface 36 of the second network node 30, 60).

The message comprises an indication that a second NF node of the one or more second NF nodes is under testing in the network. Advantageously, the indication signals to the first network node that the second NF node is a candidate for selection when selecting at least one second NF node of the one or more second NF nodes towards which network traffic is to be transmitted, and/or the message comprises load information for the second NF node and, advantageously, the indication signals to the first network node that the load information is representative of a predefined amount of network traffic that the second NF node is required to receive.

In existing load control mechanisms, load information is indicative of the load on (e.g. a resource usage at) the second NF node. However, by virtue of the indication referred to herein, these standard load control mechanisms can be updated such that the load information does not refer to the load on the second NF node and instead advantageously refers to an expected load that is to be transmitted to the second NF node. In the art, load information may also be referred to as load control information.

Herein, a second NF node or an update (such as a software, e.g. new service, update) to a second NF node of the one or more second NF nodes that is under testing in the network may already have been fully or partly tested in isolation away from the network, such as in a lab (e.g. at the vendor premises) prior to it being under testing in the network. In some situations, for example, the second NF node may have been tested in isolation away from the network, but the interaction of the second NF node with other NF nodes may need to be tested in the network. Similarly, for example, a service that is newly introduced to (or any other update to) the second NF node may have been tested in isolation away from the network, but the interaction of this newly introduced service with other services may need to be tested in the network. These interactions may cause errors. Thus, by way of the indication referred to herein signalling to the first network node that the second NF node is a candidate for selection when selecting at least one second NF node of the one or more second NF nodes towards which network traffic is to be transmitted, the second NF node can be deployed in the network in a controlled way. This control allows errors to be identified and action to be taken (e.g. by operators of the network) to avoid the errors occurring in the wider network.

For example, if errors are found to occur when testing the second NF node in the network, the second NF node may be removed from the network or any upgrades (e.g. software upgrades) or modifications to the second NF node may be removed or reversed. The second NF node that is under testing in the network may, for example, be a second NF node that has been newly introduced into the network or a second NF node that is already included in the network but that has been upgraded or modified (e.g. itself upgraded or modified, and/or the service(s) it can provide upgraded or modified), or the second NF node may be under testing in the network for any other reason. Thus, in the manner described herein, it is possible to limit the impact of a newly introduced NF node and/or a newly introduced upgrade or modification potentially malfunctioning as action can be taken prior to expanding the use of this NF node and/or upgrade or modification in the network (e.g. to the whole network).

In some embodiments, a profile of the second NF node 30 may comprise the indication and/or the load information referred to herein. In some embodiments, the profile may comprise one or more attributes for the second NF node 30 and an attribute of the one or more attributes for the second NF node 30 can be set to the indication. Although not illustrated in FIG. 3, in some embodiments, the method may comprise setting the attribute to the indication. The attribute may, for example, be a locality attribute indicative of a location of the second NF node 30, or any other attribute for the second NF node 30. In some embodiments, the attribute may be an attribute that is to be prioritised (e.g. considered first) when selecting the at least one second NF node 30.

In some embodiments, the attribute may be an attribute that matches or at least partially matches a corresponding attribute for the first NF node. In some embodiments, for example, the attribute may be set to a value and the attribute may match the corresponding attribute when the value of the attribute is the same as a value of the corresponding attribute. Similarly, for example, the attribute may be set to multiple values and the attribute may match the corresponding attribute when the values of the attribute are the same as the values of the corresponding attribute or the attribute may partially match the corresponding attribute when one or more (or a predefined percentage) of the values of the attribute are the same as one or more of the values of the corresponding attribute. In some embodiments, the first NF node also may be under testing in the network.

In some embodiments where the second network node is the second NF node, the message can be a response to a service request. The service request is a request for a second NF node to provide a service requested by a first NF node of the service consumer. Generally, a service is software intended to be managed for a user. Herein, a service can be any type of service, such as a communication service (e.g. a notification service or a callback service), a context management (e.g. user equipment context management (UECM)) service, a data management (DM) service, or any other type of service. Herein, references to providing a service can refer to, for example, executing or running the service.

In other embodiments where the second network node is the NRF node, the message may comprise the profile of the second NF node mentioned earlier. In some of these embodiments, transmission of the message may be initiated in response to a change to the load information (e.g. that the profile comprises) and/or in response to a discovery request. The discovery request is a request for information indicative of one or more second NF nodes for providing the service requested by the first NF node. In some embodiments, the first network node may be subscribed to be notified of a change to the load information.

In some embodiments, the message can comprise a load control information (LCI) header and the LCI header may comprise the indication. In some embodiments, the predefined amount of network traffic that the second NF node is required to receive may be a predefined percentage of a total amount of network traffic available for transmission.

In some embodiments, the selecting of at least one second NF node 30 of the one or more second NF nodes may be for the at least one second NF node 30 to provide a service requested by the first NF node 20 and/or the network traffic may comprise a service request, where the service request is a request for the service (requested by the first NF node 20) to be provided.

Although not illustrated in FIG. 3, in some embodiments where the second network node is the second NF node 30, the method may comprise receiving network traffic, such as the predefined amount of network traffic (e.g. via a communications interface 36 of the second NF node 30). In some embodiments, network traffic, such as the predefined amount of network traffic, may also be received by at least one other second NF node that is of the same type as the second NF node 30 (e.g. in the case of initial selection) and/or that is in the same group of second NF nodes as the second NF node 30 (e.g. in the case of reselection). In some embodiments, network traffic, such as a remaining amount of network traffic available for transmission (or the rest of the traffic), may be received by at least one other second NF node of the one or more second NF nodes. In some embodiments, at least two other second NF nodes of the one or more second NF nodes may receive network traffic, e.g. the remaining amount of network traffic. In these embodiments, the network traffic can be distributed among the at least two other second NF nodes to balance a load on the at least two other second NF nodes.

As mentioned earlier, in existing load control mechanisms, load information can be indicative of a load on (e.g. a resource usage at) the second NF node. However, by virtue of the indication referred to herein, these standard load control mechanisms can be updated such that the load information does not refer to the load on the second NF node and instead advantageously refers to an expected load that is to be transmitted to the second NF node. In some embodiments, the load information described herein may comprise a value that is normally indicative of a load on the second NF node, such as a value between 0 and 100. For example, in existing control mechanisms, a value of 0 is indicative that there is no load on the second NF node (e.g. no resources are in use at the second NF node) and a value of 100 is indicative that the second NF node has a full load (e.g. all resources are in use at the second NF node). However, by way of the indication referred to herein, the first network node can be notified that this value is actually indicative of an expected load that is to be transmitted to the second NF node. For example, if the load information comprises a value of 30, then the first network node can be notified by way of the indication that 30% of the total amount of network traffic needs to be transmitted towards the second NF node. The rest of the network traffic, i.e. 70%, may be distributed (e.g. load balanced) among other second NF nodes.

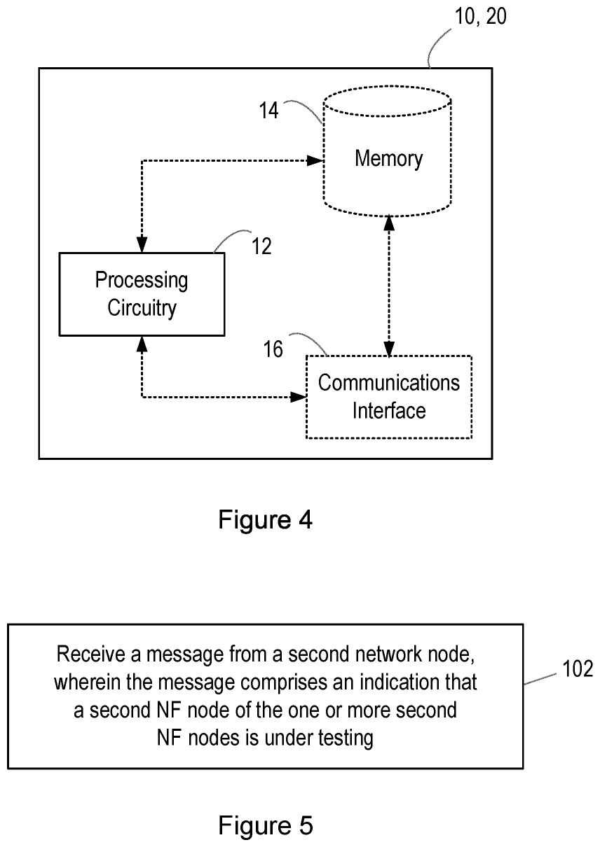

FIG. 4 illustrates a first network node 10, 20 in accordance with an embodiment. The first network node 10, 20 is for handling messages in a fifth generation network. In some embodiments, the first network node 10, 20 can, for example, be a physical machine (e.g. a server) or a virtual machine (VM). The first network node 10, 20 can be a first NF node 20 of a service consumer or a first SCP node 10 that is configured to operate as an SCP between the first NF node 20 and one or more second NF nodes of a service producer.

As illustrated in FIG. 4, the first network node 10, 20 comprises processing circuitry (or logic) 12. The processing circuitry 12 controls the operation of the first network node 10, and can implement the method described herein in respect of the first network node 10, 20. The processing circuitry 12 can be configured or programmed to control the first network node 10, 20 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first network node 10, 20. In some embodiments, the processing circuitry 12 can be configured to run software to perform the method described herein in respect of the first network node 10, 20. The software may be containerised according to some embodiments. Thus, in some embodiments, the processing circuitry 12 may be configured to run a container to perform the method described herein in respect of the first network node 10, 20.

Briefly, the processing circuitry 12 of the first network node 10, 20 is configured to receive a message from a second network node. The message comprises an indication that a second NF node of the one or more second NF nodes is under testing in the network. The indication signals to the first network node that the second NF node is a candidate for selection when selecting at least one second NF node of the one or more second NF nodes towards which network traffic is to be transmitted, and/or the message comprises load information for the second NF node and the indication signals to the first network node that the load information is representative of a predefined amount of network traffic that the second NF node is required to receive.

As illustrated in FIG. 4, in some embodiments, the first network node 10, 20 may optionally comprise a memory 14. The memory 14 of the first network node 10, 20 can comprise a volatile memory or a non-volatile memory. In some embodiments, the memory 14 of the first network node 10, 20 may comprise a non-transitory media. Examples of the memory 14 of the first network node 10, 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the first network node 10, 20 can be communicatively coupled (e.g. connected) to the memory 14 of the first network node 10, 20. In some embodiments, the memory 14 of the first network node 10, 20 may be for storing program code or instructions which, when executed by the processing circuitry 12 of the first network node 10, 20, cause the first network node 10, 20 to operate in the manner described herein in respect of the first network node 10, 20. For example, in some embodiments, the memory 14 of the first network node 10, 20 may be configured to store program code or instructions that can be executed by the processing circuitry 12 of the first network node 10, 20 to cause the first network node 10, 20 to operate in accordance with the method described herein in respect of the first network node 10, 20. Alternatively or in addition, the memory 14 of the first network node 10, 20 can be configured to store any information, data, messages, requests, responses, indications, notifications, signals, or similar, that are described herein. The processing circuitry 12 of the first network node 10, 20 may be configured to control the memory 14 of the first network node 10, 20 to store information, data, messages, requests, responses, indications, notifications, signals, or similar, that are described herein.

In some embodiments, as illustrated in FIG. 4, the first network node 10, 20 may optionally comprise a communications interface 16. The communications interface 16 of the first network node 10, 20 can be communicatively coupled (e.g. connected) to the processing circuitry 12 of the first network node 10, 20 and/or the memory 14 of the first network node 10, 20. The communications interface 16 of the first network node 10, 20 may be operable to allow the processing circuitry 12 of the first network node 10, 20 to communicate with the memory 14 of the first network node 10, 20 and/or vice versa. Similarly, the communications interface 16 of the first network node 10, 20 may be operable to allow the processing circuitry 12 of the first network node 10, 20 to communicate with the second network node 30, 60 and/or any other node mentioned herein. The communications interface 16 of the first network node 10, 20 can be configured to transmit and/or receive information, data, messages, requests, responses, indications, notifications, signals, or similar, that are described herein. In some embodiments, the processing circuitry 12 of the first network node 10, 20 may be configured to control the communications interface 16 of the first network node 10, 20 to transmit and/or receive information, data, messages, requests, responses, indications, notifications, signals, or similar, that are described herein.

Although the first network node 10, 20 is illustrated in FIG. 4 as comprising a single memory 14, it will be appreciated that the first network node 10, 20 may comprise at least one memory (i.e. a single memory or a plurality of memories) 14 that operates in the manner described herein. Similarly, although the first network node 10, 20 is illustrated in FIG. 4 as comprising a single communications interface 16, it will be appreciated that the first network node 10, 20 may comprise at least one communications interface (i.e. a single communications interface or a plurality of communications interface) 16 that operates in the manner described herein. It will also be appreciated that FIG. 4 only shows the components required to illustrate an embodiment of the first network node 10, and, in practical implementations, the first network node 10, 20 may comprise additional or alternative components to those shown.

FIG. 5 illustrates a method performed by a first network node 10, 20 in accordance with an embodiment. The method is for handling messages in a fifth generation network. The first network node 10, 20 described earlier with reference to FIG. 4 can be configured to operate in accordance with the method of FIG. 5. In some embodiments, the method can be performed by or under the control of the processing circuitry 12 of the first network node 10, 20.

As illustrated at block 102 of FIG. 5, a message is received from a second network node (e.g. via a communications interface 16 of the first network node 10, 20). The message comprises an indication that a second NF node of the one or more second NF nodes is under testing in the network. The indication signals to the first network node that the second NF node is a candidate for selection when selecting at least one second NF node of the one or more second NF nodes towards which network traffic is to be transmitted, and/or the message comprises load information for the second NF node and advantageously the indication signals to the first network node that the load information is representative of a predefined amount of network traffic that the second NF node is required to receive.

In some embodiments, a profile of the second NF node 30 may comprise the indication and/or the load information. In some embodiments, the profile may comprise one or more attributes for the second NF node 30 and an attribute of the one or more attributes for the second NF node 30 can be set to the indication. The attribute may, for example, be a locality attribute indicative of a location of the second NF node 30, or any other attribute for the second NF node 30. In some embodiments, the attribute may be an attribute that is to be prioritised when selecting the at least one second NF node 30. In some embodiments, the attribute may be an attribute that matches or at least partially matches a corresponding attribute for the first NF node, e.g. as described earlier. In some embodiments, the first NF node may be under testing in the network.

As mentioned earlier, the second network node can be the second NF node 30 or an NRF node 60. In some embodiments where the second network node is the second NF node 30, the message can be a response to a service request. The service request is a request for the second NF node 30 to provide a service requested by the first NF node 20. In other embodiments where the second network node is the NRF node 60, the message may comprise the profile of the second NF node 30 mentioned earlier.

In some embodiments, the message may be received in response to a change to the load information (e.g. that the profile comprises) and/or in response to a discovery request. The discovery request is a request for information indicative of one or more second NF nodes for providing a service requested by the first NF node 20. In some embodiments, the first network node 10, 20 may be subscribed to be notified of a change to the load information.

In some embodiments, the message can comprise a load control information (LCI) header and the LCI header may comprise the indication. In some embodiments, the predefined amount of network traffic that the second NF node 30 is required to receive can be a predefined percentage of a total amount of network traffic available for transmission.

Although not illustrated in FIG. 5, in some embodiments, the method may comprise selecting at least one second NF node 30 of the one or more second NF nodes towards which network traffic is to be transmitted. In these embodiments, the selection can be based on the indication. For example, the at least one second NF node 30 can be selected from one or more second NF nodes that such an indication signals is a candidate for selection. In some cases, there may be only one second NF node signalled to be a candidate for selection, in which case this second NF node can be selected. In other cases, there may be a plurality of second NF nodes signalled to be candidates for selection, in which case at least one these second NF nodes can be selected, e.g. based on one or more criteria. The one or more criteria may, for example, comprise load (e.g. the second NF node that requires a predefined load and/or that currently has the lowest load may be selected), locality (e.g. the second NF node closest to the first NF node may be selected), priority (e.g. the second NF node having the highest priority may be selected), capacity (e.g. the second NF node having the greatest capacity or the greatest available capacity may be selected), and/or any other criteria. In some embodiments, the selecting of at least one second NF node 30 of the one or more second NF nodes may be for the at least one second NF node to provide a service requested by the first NF node 20 and/or the network traffic may comprise a service request, where the service request is a request for the service 40 (requested by the first NF node 20) to be provided.

Although also not illustrated in FIG. 5, in some embodiments, the method may comprise initiating transmission of network traffic, e.g. the predefined amount of network traffic that the second NF node is required to receive, towards the second NF node. For example, the first network node 10, 20 (e.g. the processing circuitry 12 of the first network node 10, 20) can be configured to itself transmit this network traffic or can be configured to cause another node to transmit this network traffic (e.g. via a communications interface 16 of the first network node 10, 20). Alternatively or in addition, in some embodiments, the method may comprise initiating transmission of network traffic, e.g. the predefined amount of network traffic that the second NF node is required to receive, towards at least one other second NF node that is of the same type as the second NF node (e.g. in the case of initial selection) and/or that is in the same group of second NF nodes as the second NF node (e.g. in the case of reselection).

Although also not illustrated in FIG. 5, in some embodiments, the method may comprise initiating transmission of network traffic, e.g. a remaining amount of network traffic available for transmission (or the rest of the traffic), towards at least one other second NF node of the one or more second NF nodes. For example, the first network node 10, 20 (e.g. the processing circuitry 12 of the first network node 10, 20) can be configured to itself transmit this network traffic or can be configured to cause another node to transmit this network traffic (e.g. via a communications interface 16 of the first network node 10, 20). In some of these embodiments, transmission of network traffic, e.g. the remaining amount of network traffic, may be initiated towards at least two other second NF nodes of the one or more second NF nodes. In these embodiments, the network traffic can be distributed among the at least two other second NF nodes to balance a load on the at least two other second NF nodes.

There is also provided a method performed by a system. The method comprises the method described herein in respect of the first network node 10, 20 and the method described herein in respect of the second network node 30, 60. There is also provided a system comprising at least one first network node 10, 20 as described herein and at least one second network node 30, 60 as described herein.

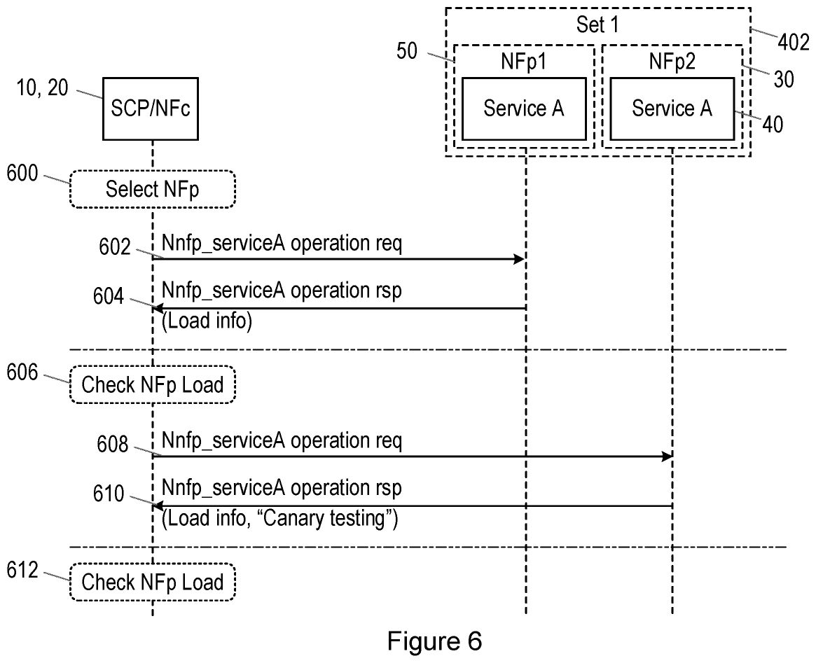

FIG. 6 is a signalling diagram illustrating an exchange of signals in a system according to an embodiment. The system illustrated in FIG. 6 comprises a first network node 10, 20 and one or more second NF nodes 30, 50 of a service producer (“NFp1”, “NFp2”).

The system of FIG. 6 illustrates an embodiment where the second network node mentioned earlier is a second NF node 30 of the one or more second NF nodes 30, 50. Thus, the second NF node 30 can be as described earlier with reference to FIGS. 2 and 3. The first network node 10, 20 can be as described earlier with reference to FIGS. 4 and 5. The first network node 10, 20 can be a first SCP node 10 (“SCP”) or a first NF node 20 of a first service consumer (“NFc”). Although not illustrated in FIG. 6, in some embodiments where the first network node 10 is a first SCP node 10, the system may also comprise a first NF node 20. The first SCP node 10 can be configured to operate as an SCP between the first NF node 20 and the one or more second NF nodes 30, 50.

The one or more second NF nodes 30, 50 can each be for providing, e.g. configured to provide, a service 40 (“Service A”). In some embodiments, as illustrated in FIG. 6, a group (or set) 402 of second NF nodes (“Set 1”) may comprise the one or more second NF nodes 30, 50. Although two second NF nodes 30, 50 are illustrated in FIG. 6, it will be understood that the group 402 of second NF nodes may comprise a single second NF node according to some embodiments or a plurality of (e.g. two, three or more) second NF nodes according to other embodiments.

Although not illustrated in FIG. 6, in some embodiments, the system may also comprise an NRF node. In some of these embodiments, where the system also comprises the first SCP node 10, an entity may comprise the first SCP node 10 and the NRF node. That is, in some embodiments, the first SCP node 10 can be merged with the NRF node in a combined entity. Generally, an NRF node is a node that provides NF service registration and discovery. An NRF node thus enables NF nodes to identify services offered by other NF nodes.

Although only one first network node 10, 20 (e.g. one first SCP node 10 or one first NF node 20) is illustrated in FIG. 6, the system can comprise one or more first network nodes (e.g. one or more first SCP nodes 10 and/or one or more first NF nodes 20). Similarly, although only one group (or set) 402 of second NF nodes 30, 50 is illustrated in FIG. 6, the system can comprise one or more groups (or sets) of second NF nodes. In some embodiments, the one or more second NF nodes 30, 50 may be grouped according to the type of NF node and/or according to a service that they can provide. For example, second NF nodes 30, 50 of the same type and/or that can provide the same service 40 can be part of the same group 402.

In some embodiments, the first SCP node 10 and the first NF node 20 may be deployed in independent deployment units and/or the first SCP node 10 and at least one of the one or more second NF nodes 30, 50 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20 and/or part (e.g. a service agent) of the first SCP node 10 may be deployed in the same deployment unit as at least one of the one or more second NF nodes 30, 50. Thus, an SCP node based on a service mesh is possible, as described in 3GPP TS 23.501 V16.4.0.

In some embodiments, at least one second SCP node may be configured to operate as an SCP between the first NF node 20 and the first SCP node 10 and/or at least one third SCP node may be configured to operate as an SCP between the first SCP node 10 and at least one of the one or more second NF nodes 30, 50. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

As illustrated by block 600 of FIG. 6, the first network node 10, 20 selects a second NF node 50 (or an instance of a second NF node 50) to provide a service 40 requested by the first NF node 20. Thus, in some embodiments, the first NF node 20 may itself select a second NF node 50 to provide the service 40. In other embodiments, the first SCP node 10 may select a second NF node 50 to provide the service 40. For example, although not illustrated in FIG. 6, in some of these other embodiments, the first NF node 20 may initiate transmission of (e.g. itself transmit or cause another node to transmit, such as via a communications interface 16 of the first NF node 20) a service request towards the first SCP node 10 and the first SCP node 10 may thus receive this service request (e.g. via a communications interface 16 of the first SCP node 10). This service request, which is received by the first SCP node 10, can be a request for a second NF node 50 to provide the service 40 requested by the first NF node 20. In some embodiments, this service request may comprise discovery and/or selection parameters. For example, the first NF node 20 may provide the first SCP node 10 with all the functional parameters that are required to find a suitable second NF node to provide the service 40. In the other embodiment, where the first NF node 20 is itself responsible for selecting a second NF node 50 to provide the service 40, it is the first NF node 20 that finds a suitable second NF node.

The first network node 10, 20 can find a suitable second NF node using a discovery process. For example, although not illustrated in FIG. 6, in some embodiments, the first network node 10, 20 may initiate transmission of (e.g. itself transmit or cause another node to transmit, such as via a communications interface 16 of the first network node 10, 20) a discovery request towards an NRF node and thus the NRF node receives this discovery request. The discovery request is a request for information indicative of one or more second NF nodes of one or more service producers for providing the service 40 requested by the first NF node 20. The discovery request can comprise discovery and/or selection parameter(s). The NRF node can discover profiles of possible destination second NF nodes of one or more service producers based on the discovery parameter(s) received.

At block 600 of FIG. 6, the first network node 10, 20 can then select a second NF node 50 (or an instance of a second NF node 50) from the corresponding profile(s). That is, at block 600 of FIG. 6, the first network node 10, 20 can select one second NF node 50 among the ones provided (i.e. from the available candidates 30, 50). A person skilled in the art will be aware of various criteria on the basis of which the selection can be performed, such as any of those mentioned earlier. As this is the first service request, the first network node 10, 20 does not have any load information for the one or more second NF nodes 30, 50 from which a second NF node 50 is selected. Therefore, the first network node 10, 20 may assume that there is zero load on each of one or more second NF nodes 30, 50.

Returning back to FIG. 6, as illustrated by arrow 602, the first network node 10, 20 may initiate transmission of (e.g. itself transmit or cause another node to transmit, such as via a communications interface 16 of the first network node 10, 20) a service request towards the selected second NF node 50. This service request 602 will be referred to herein as the “first service request”. In embodiments where the first network node 10, 20 is the first NF node 20, the first NF node 20 may transmit the first service request 602 directly to the selected second NF node 50 or may transmit the first service request 602 indirectly towards the selected second NF node 50 via the first SCP node 10 and/or any other SCP node. The selected second NF node 50 receives the first service request 602 (e.g. via a communications interface of the selected second NF node 50). The first service request 602 is a request for the selected second NF node 50 to provide the service 40 requested by the first NF node 20. The service 40 may, for example, be requested by the first NF node 20 for a subscriber (e.g. user or user equipment, UE).

As illustrated by arrow 604 of FIG. 6, the selected second NF node 50 may initiate transmission of (e.g. itself transmit or cause another node to transmit, such as via a communications interface of the selected second NF node 50) a first response to the first service request 602 towards the first network node 10, 20. Thus, the first network node 10, 20 receives this first response 604 from the second NF node 50 that is selected to provide the service 40. In embodiments where the first network node 10, 20 is the first NF node 20, the first NF node 20 may receive the first response 604 directly from the selected second NF node 50 or may receive the first response 604 indirectly from the selected second NF node 50 via the first SCP node 10 and/or any other SCP node. The first response 604 comprises load information for the selected second NF node 30 of the one or more second NF nodes 30, 50. In some embodiments, the first response 604 may comprise a load control information (LCI) header and the LCI header can comprise the load information.

The first network node 10, 20 may need to send another request for a second NF node to provide a service 40 requested by the first NF node 20. In this case, as illustrated by block 606 of FIG. 6, the first network node 10, 20 may check the load on the one or more second NF nodes 30, 50 and select a second NF node 30 (or an instance of a second NF node 30) of the one or more second NF nodes 30, 50 to provide the service requested by the first NF node 20. This selection can be a new initial selection. In some embodiments, the one or more second NF nodes 30, 50 can be the one or more candidate second NF nodes 30, 50 that were found during the discovery process described above. The selected second NF node 30 may be the same second NF node as that which was previously selected or a different second NF node to that which was previously selected. For the purpose of illustration, it is assumed that a different second NF node 30 is selected. This time, the selection can be based on the load information. For example, if the load information for a second NF node 30 is indicative that the load on this second NF node 30 is zero, then this second NF node 30 may be selected. In another example, if load information is received for at least two second NF nodes, the second NF node 30 that is known from the load information to have the lowest load out of the at least two second NF nodes can be selected.

Although not illustrated in FIG. 6, in some embodiments, the first network node 10, 20 may check one or more other criteria before taking into account the load information. For example, in some embodiments, the first network node 10, 20 may first check a locality of the one or more second NF nodes 30, 50 and/or a priority assigned to the one or more second NF nodes 30, 50 before checking the load on the one or more second NF nodes 30, 50. Thus, in some embodiments, the selection of a second NF node to provide the service requested by the first NF node 20 may be performed based on the load and optionally also one or more other criteria. In some embodiments, if there are multiple second NF node candidates for selection, the first network node 10, 20 may base the selection on a relative load for each second NF node candidate, where the relative load is based on an absolute (or actual) load on the second NF node and the capacity of the second NF node.

As illustrated by arrow 608 of FIG. 6, the first network node 10, 20 initiates transmission of (e.g. itself transmits or causes another node to transmit, such as via a communications interface 16 of the first network node 10, 20) a service request towards the selected second NF node 30. This service request 608 will be referred to herein as the “second service request”. In embodiments where the first network node 10, 20 is the first NF node 20, the first NF node 20 may transmit the second service request 608 directly to the selected second NF node 30 or may transmit the second service request 608 indirectly towards the selected second NF node 30 via the first SCP node 10 and/or any other SCP node. The selected second NF node 30 receives the second service request 608 (e.g. via a communications interface 36 of the selected second NF node 30). The second service request 608 is a request for the selected second NF node 30 to provide the service 40 requested by the first NF node 20. The service 40 may, for example, be requested by the first NF node 20 for a subscriber (e.g. user or user equipment, UE).

As illustrated by arrow 610 of FIG. 6, the selected second NF node 30 initiates transmission of (e.g. itself transmits or causes another node to transmit, such as via a communications interface of the selected second NF node 50) a second response towards the first network node 10, 20. Thus, the first network node 10, 20 receives this second response 610 from the second NF node 30 that is selected to provide the service 40. This second response 610 may also be referred to herein as a “message”. In embodiments where the first network node 10, 20 is the first NF node 20, the first NF node 20 may receive the second response 610 directly from the selected second NF node 30 or may receive the second response 610 indirectly from the selected second NF node 30 via the first SCP node 10 and/or any other SCP node.

The second response comprises an indication (e.g. a flag) that the selected second NF node 30 of the one or more second NF nodes 30, 50 is under testing in the network. The second response also comprises load information for the selected second NF node 30. Advantageously, the indication signals (e.g. flags) to the first network node 10, 20 that the load information is representative of a predefined amount of network traffic (or load) that the second NF node 30 is required to receive. That is, the second response advantageously comprises an indication that signals (e.g. flags) that the load information is to be interpreted as the expected amount of network traffic (or load) to be received by the second NF node 30. The second NF node 30 may, for example, require the predefined amount of network traffic to undergo testing (e.g. canary testing) in the network. In some embodiments, the second response 610 may comprise an LCI header and the LCI header can comprise the load information and/or the indication. In some embodiments, a profile of the selected second NF node 30 can comprise the load information and/or the indication.

Thus, the first network node 10, 20 advantageously has knowledge that the selected second NF node 30 requires a predefined amount of traffic (or load). In some embodiments, the predefined amount of network traffic that the selected second NF node 30 is required to receive may be a predefined percentage of a total amount of network traffic available for transmission. For example, if the load information comprises a value of 20, this may indicate that the selected second NF node 30 is required to receive 20% of the total amount of network traffic available for transmission.

As illustrated by arrow 612 of FIG. 6, the method may be repeated any one or more times, e.g. by the first network node 10, 20 again checking the load on the one or more second NF nodes 30, 50 as described earlier with reference to block 606. However, this time, the first network node 10, 20 knows that the load information that it checks at block 606 of FIG. 6 is representative of a predefined amount of network traffic (or load) that the second NF node 30 is required to receive and thus this can be taken into account when selecting a second NF node 30, 50 to which to transmit network traffic.

For example, although not illustrated in FIG. 6, in some embodiments, the first network node 10, 20 may initiate transmission of (e.g. itself transmit or cause another node to transmit, such as via a communications interface 16 of the first network node 10, 20) the predefined amount of network traffic (or load) that the second NF node 30 is required to receive towards the second NF node 30. In embodiments where the first network node 10, 20 is the first NF node 20, the first NF node 20 may transmit the predefined amount of network traffic directly to the selected second NF node 30 or may transmit the predefined amount of network traffic indirectly towards the selected second NF node 30 via the first SCP node 10 and/or any other SCP node. The selected second NF node 30 receives the predefined amount of network traffic (e.g. via a communications interface of the selected second NF node 30).

Although also not illustrated in FIG. 6, in some embodiments, the first network node 10, 20 may initiate transmission of a remaining amount of network traffic (or load) available for transmission towards at least one other second NF node 50 of the one or more second NF nodes. For example, if the predefined amount of network traffic (or load) that the second NF node 30 is required to receive is 10% of the total amount of network traffic available for transmission, then the first network node 10, 20 can initiate transmission of 10% of the total amount of network traffic towards this second NF node and the remaining 90% of total amount of network traffic towards the at least one other second NF node 50.

In embodiments where the first network node 10, 20 is the first NF node 20, the first NF node 20 may transmit the remaining amount of network traffic directly to the at least one other second NF node 50 or may transmit the remaining amount of network traffic indirectly towards the at least one other second NF node 50 via the first SCP node 10 and/or any other SCP node. The at least one other second NF node 50 receives the remaining amount of network traffic (e.g. via a communications interface of the selected second NF node 30). The at least one other second NF node 50 can be at least one other second NF node 50 that has not provided any such indication (e.g. flag) as that mentioned earlier, i.e. the at least one other second NF node 50 has not indicated that it is required to receive a predefined amount of network traffic (or load).

In some embodiments, transmission of the remaining amount of network traffic (or load) may be initiated towards at least two other second NF nodes of the one or more second NF nodes, e.g. in the manner described earlier. The at least two other second NF node can be at least two other second NF nodes that have not provided any such indication (e.g. flag) as that mentioned earlier, i.e. the at least two other second NF nodes have not indicated that they are required to receive a predefined amount of network traffic (or load). In some of these embodiments, the remaining amount of network traffic can be distributed among the at least two other second NF nodes, e.g. to balance a load on the at least two other second NF nodes. For example, in some embodiments, the first network node 10, 20 may consider a relative load on the at least two other second NF nodes 50 to load balance the remaining amount of network traffic among the at least two other second NF nodes.

The network traffic referred to herein can be any type of network traffic, e.g. any network traffic that is to be transmitted by the first network node 10, 20 towards one or more second NF nodes 30, 50. For example, the network traffic can comprise one or more requests for a service 40 to be provided by one or more second NF nodes 30, 50, one or more other requests, data associated with one or more of these request(s), and/or any other data.

In some embodiments where the network traffic comprises one or more requests for a service 40 to be provided by one or more second NF nodes 30, 50, the first network node 10, 20 may decide at block 612 of FIG. 6 which of the possible candidate second NF nodes 30, 50 are to receive the one or more requests based on the load information. For example, if one of the candidate second NF nodes 30 still needs to receive a certain amount of network traffic to reach the predefined amount of network traffic that it is required to receive, then the one or more requests may be transmitted towards this candidate second NF node 30. Otherwise, the one or more requests may be transmitted to another one or more of the candidate second NF nodes 50. In some embodiments, the method described with reference to block 612 of FIG. 6 onward may be repeated each time a service needs to be requested by the first NF node 20.

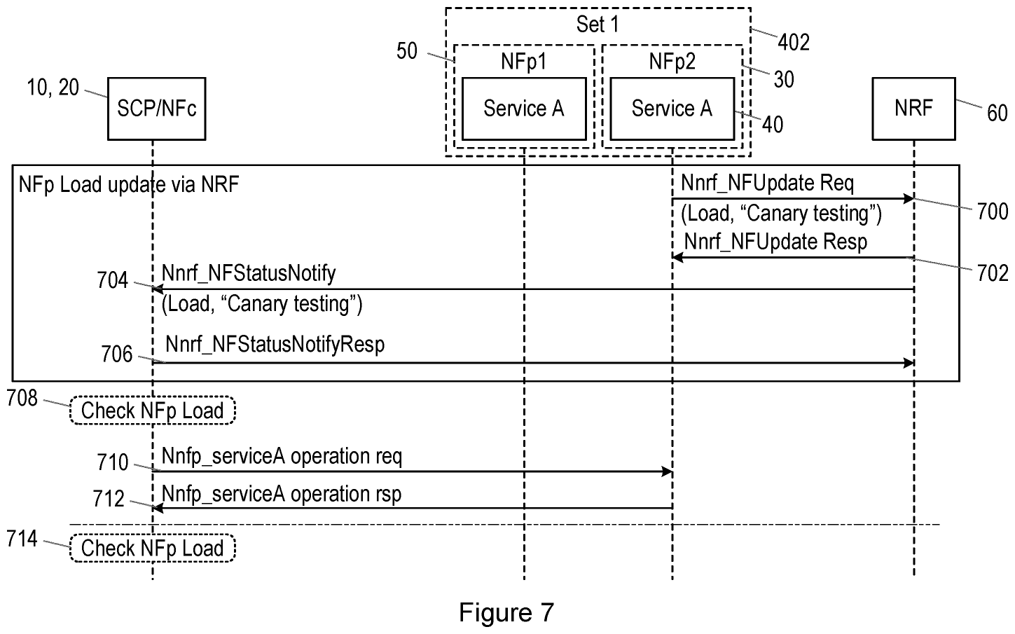

FIG. 7 is a signalling diagram illustrating an exchange of signals in a system according to an embodiment. The system illustrated in FIG. 7 comprises a first network node 10, 20, one or more second NF nodes 30, 50 of a service producer (“NFp1”, “NFp2”), and an NRF node 60. The system of FIG. 7 illustrates an embodiment where the second network node mentioned earlier is the NRF node 60. Thus, the NRF node 60 can be as described earlier with reference to FIGS. 2 and 3. The first network node 10, 20 can be as described earlier with reference to FIGS. 4 and 5. The first network node 10, 20 can be a first SCP node 10 (“SCP”) or a first NF node 20 of a first service consumer (“NFc”). Although not illustrated in FIG. 7, in some embodiments where the first network node 10 is a first SCP node 10, the system may also comprise a first NF node 20. The first SCP node 10 can be configured to operate as an SCP between the first NF node 20 and the one or more second NF nodes 30, 50.

The one or more second NF nodes 30, 50 can each be for providing, e.g. configured to provide, a service 40 (“Service A”). In some embodiments, as illustrated in FIG. 7, a group (or set) 402 of second NF nodes (“Set 1”) may comprise the one or more second NF nodes 30, 50. Although two second NF nodes 30, 50 are illustrated in FIG. 7, it will be understood that the group 402 of second NF nodes may comprise a single second NF node according to some embodiments or a plurality of (e.g. two, three or more) second NF nodes according to other embodiments.

In some of embodiments, where the system comprises the first SCP node 10, an entity may comprise the first SCP node 10 and the NRF node 60. That is, in some embodiments, the first SCP node 10 can be merged with the NRF node 60 in a combined entity. Generally, an NRF node 60 is a node that provides NF service registration and discovery. An NRF node 60 thus enables NF nodes to identify services offered by other NF nodes.

Although only one first network node 10, 20 (e.g. one first SCP node 10 or one first NF node 20) is illustrated in FIG. 7, the system can comprise one or more first network nodes (e.g. one or more first SCP nodes 10 and/or one or more first NF nodes 20). Similarly, although only one group (or set) 402 of second NF nodes 30, 50 is illustrated in FIG. 7, the system can comprise one or more groups (or sets) of second NF nodes. In some embodiments, the one or more second NF nodes 30, 50 may be grouped according to the type of NF node. For example, second NF nodes 30, 50 of the same type and/or that can provide the same service 40 can be part of the same group 402.

In some embodiments, the first SCP node 10 and the first NF node 20 may be deployed in independent deployment units and/or the first SCP node 10 and at least one of the one or more second NF nodes 30, 50 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20 and/or part (e.g. a service agent) of the first SCP node 10 may be deployed in the same deployment unit as at least one of the one or more second NF nodes 30, 50. Thus, an SCP node based on a service mesh is possible, as described in 3GPP TS 23.501 V16.4.0.

In some embodiments, at least one second SCP node may be configured to operate as an SCP between the first NF node 20 and the first SCP node 10 and/or at least one third SCP node may be configured to operate as an SCP between the first SCP node 10 and at least one of the one or more second NF nodes 30, 50. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

As illustrated by arrow 700 of FIG. 7, a second NF node 30 of the one or more second NF nodes 30, 50 may initiate transmission of (e.g. itself transmit or cause another node to transmit, such as via a communications interface of the second NF node 30) a message towards the NRF node 60. The message 700 comprises an indication (e.g. a flag) that the second NF node 30 is under testing in the network. The message 700 also comprises load information for the second NF node 30. Advantageously, the indication signals (e.g. flags) to the NRF node 60 that the load information is representative of a predefined amount of network traffic (or load) that the second NF node 30 is required to receive. That is, the message advantageously comprises an indication that signals (e.g. flags) that the load information is to be interpreted as the expected amount of network traffic (or load) to be received by the second NF node 30. The second NF node 30 may, for example, require the predefined amount of network traffic to undergo testing (e.g. canary testing) in the network.

In some embodiments, the second NF node 30 may initiate transmission of such a message towards the NRF node 60 in response to a change to the load information for the second NF node 30. That is, the message may notify the NRF node 60 of a change to the load information for the second NF node 30 according to some embodiments. The NRF node 60 receives the message (e.g. via a communications interface 36 of the NRF node 60).

As illustrated by arrow 702 of FIG. 7, in some embodiments, the NRF node 60 may initiate transmission of (e.g. itself transmit or cause another node to transmit, such as via a communications interface of the second NF node 30) a response to the message towards the second NF node 30. The response can acknowledge that the message 700 has been received. In some embodiments, a profile of the second NF node 30 stored at the NRF node 60 may comprise load information for the second NF node 30. In these embodiments, the NRF node 60 may update the load information of the profile of the second NF node 30 with the load information received by way of the message 700. In these embodiments, the response to the message may comprise information indicative that the profile has been updated with the received load information. In some embodiments, the profile of the second NF node 30 can comprise the indication that signals that the load information is representative of a predefined amount of network traffic that the second NF node 30 is required to receive.

As illustrated by arrow 704 of FIG. 7, the NRF node 60 initiates transmission of (e.g. itself transmits or causes another node to transmit, such as via a communications interface of the second NF node 30) a message towards the first network node 10, 20. The message 704 comprises the indication (e.g. a flag) that the second NF node 30 is under testing in the network. The message 704 also comprises load information for the second NF node 30. Advantageously, the indication signals (e.g. flags) to the first network node 10, 20 that the load information is representative of a predefined amount of network traffic that the second NF node 30 is required to receive. In some embodiments, the predefined amount of network traffic that the selected second NF node is required to receive may be a predefined percentage of a total amount of network traffic available for transmission. For example, if the load information comprises a value of 20, this may indicate that the selected second NF node 30 is required to receive 20% of the total amount of network traffic available for transmission.

In embodiments where there is a change to the load information for the second NF node 30, the NRF node 60 may initiate transmission of such a message 704 towards the first network node 10, 20 in response to the change. Thus, the load information that the message 704 comprises can be the updated load information. In some embodiments, the message 704 may comprise the profile of the second NF node 30 and the profile can comprise the load information. In embodiments where the profile of the second NF node is updated, the message 704 can comprise the updated profile of the second NF node 30.

The first network node 10, 20 receives the message 704 from the NRF node 60. Thus, the first network node 10, 20 has knowledge that the second NF node 30 requires a predefined amount of traffic (or load). In embodiments where there is a change to the load information, the message 704 can be received in response to the change to the load information, e.g. that the profile of the second NF node 30 may comprise. In some embodiments, the first network node 10, 20 may be subscribed to be notified of the change. As illustrated by arrow 706 of FIG. 7, in some embodiments, the first network node 10, 20 may initiate transmission of (e.g. itself transmit or cause another node to transmit, such as via a communications interface 16 of the first network node 10, 20) a response to the message towards the NRF node 60. The response can acknowledge that the message has been received.

In some embodiments, any one or more of the steps illustrated by arrows 700 to 706 may be performed for all second NF nodes 30, 50. For example, although FIG. 7 illustrates these steps only being performed for one second NF node 30, these steps may also be performed for at least one other second NF node 50 and the same description of these steps will be understood to apply. In the case of at least one other second NF node 50 not requiring a predefined amount of network traffic, these steps may still be performed for that at least one other second NF node 50 but the message will not comprise the indication that signals that a predefined amount of network traffic is required. In some embodiments, although not illustrated in FIG. 7, the steps illustrated by arrows 700 to 706 may be repeated for a second NF node 30, 50 if a load on that second NF node 30, 50 changes or needs to be updated.

Although also not illustrated in FIG. 7, alternatively or in addition to the steps illustrated by arrows 704 and 706, the first network node 10, 20 may perform the discovery process mentioned earlier. Specifically, the first network node 10, 20 may initiate transmission of a discovery request towards the NRF node 60. As mentioned earlier, the discovery request is a request for information indicative of one or more second NF nodes 30, 50 for providing a service 40 requested by the first NF node 20. The NRF node 60 can receive the discovery request. Thus, in these embodiments, the NRF node 60 may initiate transmission of a message, which comprises the load information and the indication which advantageously signals that the load information is representative of a predefined amount of network traffic that the second NF node 30 is required to receive, towards the first network node 10, 20 in response to this discovery request.

The first network node 10, 20 may need to send a service request for a second NF node to provide a service 40 requested by the first NF node 20. In this case, as illustrated by block 708 of FIG. 7, the first network node 10, 20 may check the load on the one or more second NF nodes 30, 50 and select a second NF node 30 (or an instance of the second NF node 30) of the one or more second NF nodes 30, 50 to provide the service requested by the first NF node 20. In some embodiments, the one or more second NF nodes 30, 50 can be the one or more candidate second NF nodes 30, 50 that were found during the discovery process mentioned earlier. The selection can be based on the load information. In this respect, the first network node 10, 20 knows that the load information that it checks at block 708 of FIG. 7 is representative of a predefined amount of network traffic (or load) that the second NF node 30 is required to receive and thus this can be taken into account when selecting a second NF node 30, 50 to which to transmit the service request.

In more detail, the first network node 10, 20 may decide at block 708 of FIG. 7 which of the possible candidate second NF nodes 30, 50 are to receive the service request based on the load information. For example, if one of the candidate second NF nodes still needs to receive a certain amount of network traffic to reach the predefined amount of network traffic that it is required to receive, then the service request may be transmitted towards this candidate second NF node 30. Otherwise, the service request may be transmitted to another candidate second NF node 50.

Although not illustrated in FIG. 7, in some embodiments, the first network node 10, 20 may check one or more other criteria before taking into account the load information. For example, in some embodiments, the first network node 10, 20 may first check locality of the one or more second NF nodes 30, 50 and/or a priority assigned to the one or more second NF nodes 30, 50 before checking the load on the one or more second NF nodes 30, 50. Thus, in some embodiments, the selection of a second NF node to provide the service requested by the first NF node 20 may be performed based on the load and optionally also one or more other criteria. In some embodiments, if there are multiple second NF node candidates for selection, the first network node 10, 20 may base the selection on a relative load for each second NF node candidate, where the relative load is based on an absolute (or actual) load on the second NF node and its capacity.

As illustrated by arrow 710 of FIG. 7, the first network node 10, 20 initiates transmission of (e.g. itself transmit or cause another node to transmit, such as via a communications interface 16 of the first network node 10, 20) the service request towards the selected second NF node 30. In embodiments where the first network node 10, 20 is the first NF node 20, the first NF node 20 may transmit the service request 710 directly to the selected second NF node 30 or may transmit the service request 710 indirectly towards the selected second NF node 30 via the first SCP node 10 and/or any other SCP node. The selected second NF node 30 receives the service request 710 (e.g. via a communications interface of the selected second NF node 30). The service request 710 is a request for the selected second NF node 30 to provide the service 40 requested by the first NF node 20. The service 40 may, for example, be requested by the first NF node 20 for a subscriber (e.g. user or user equipment, UE).

As illustrated by arrow 712 of FIG. 7, the selected second NF node 30 initiates transmission of (e.g. itself transmit or cause another node to transmit, such as via a communications interface of the selected second NF node 50) a response towards the first network node 10, 20. Thus, the first network node 10, 20 receives this response 712 from the second NF node 30 that is selected to provide the service 40. In embodiments where the first network node 10, 20 is the first NF node 20, the first NF node 20 may receive the response 712 directly from the selected second NF node 30 or may receive the response 712 indirectly from the selected second NF node 30 via the first SCP node 10 and/or any other SCP node.

Although the method illustrated in FIG. 7 is described with reference to a service request, it will be understood that the method can be applied to any other network traffic. As mentioned earlier, the network traffic referred to herein can be any type of network traffic, e.g. any network traffic that is to be transmitted by the first network node 10, 20 towards one or more second NF nodes 30, 50. For example, the network traffic can comprise one or more requests for a service 40 to be provided by one or more second NF nodes 30, 50, one or more other requests, data associated with one or more of these request(s), and/or any other data.

Thus, more generally, although not illustrated in FIG. 7, the first network node 10, 20 may initiate transmission of (e.g. itself transmit or cause another node to transmit, such as via a communications interface 16 of the first network node 10, 20) the predefined amount of network traffic (or load) that the second NF node 30 is required to receive towards the second NF node 30. In embodiments where the first network node 10, 20 is the first NF node 20, the first NF node 20 may transmit the predefined amount of network traffic directly to the selected second NF node 30 or may transmit the predefined amount of network traffic indirectly towards the selected second NF node 30 via the first SCP node 10 and/or any other SCP node. The selected second NF node 30 thus receives the predefined amount of network traffic (e.g. via a communications interface of the selected second NF node 30).

Although also not illustrated in FIG. 7, in some embodiments, the first network node 10, 20 may initiate transmission of a remaining amount of network traffic (or load) available for transmission towards at least one other second NF node 50 of the one or more second NF nodes. For example, if the predefined amount of network traffic (or load) that the second NF node 30 is required to receive is 10% of the total amount of network traffic available for transmission, then the first network node 10, 20 can initiate transmission of 10% of the total amount of network traffic towards this second NF node and the remaining 90% of total amount of network traffic towards the at least one other second NF node 50.

In embodiments where the first network node 10, 20 is the first NF node 20, the first NF node 20 may transmit the remaining amount of network traffic directly to the at least one other second NF node 50 or may transmit the remaining amount of network traffic indirectly towards the at least one other second NF node 50 via the first SCP node 10 and/or any other SCP node. The at least one other second NF node 50 receives the remaining amount of network traffic (e.g. via a communications interface of the selected second NF node 30). The at least one other second NF node 50 can be at least one other second NF node 50 that has not provided any such indication (e.g. flag) as that mentioned earlier, i.e. the at least one other second NF node 50 has not indicated that it is required to receive a predefined amount of network traffic (or load).

In some embodiments, transmission of the remaining amount of network traffic (or load) may be initiated towards at least two other second NF nodes of the one or more second NF nodes, e.g. in the manner described earlier. The at least two other second NF node can be at least two other second NF nodes that have not provided any such indication (e.g. flag) as that mentioned earlier, i.e. the at least two other second NF nodes have not indicated that they are required to receive a predefined amount of network traffic (or load). In some of these embodiments, the remaining amount of network traffic can be distributed among the at least two other second NF nodes, e.g. to balance a load on the at least two other second NF nodes. For example, in some embodiments, the first network node 10, 20 may consider a relative load on the at least two other second NF nodes 50 to load balance the remaining amount of network traffic among the at least two other second NF nodes.

As illustrated by arrow 714 of FIG. 7, the method may be repeated any one or more times, e.g. by the first network node 10, 20 again checking the load on the one or more second NF nodes 30, 50 as described earlier with reference to block 708 of FIG. 7. In some embodiments, the method described with reference to block 708 of FIG. 7 onward may be repeated each time a service is requested by the first NF node 20.

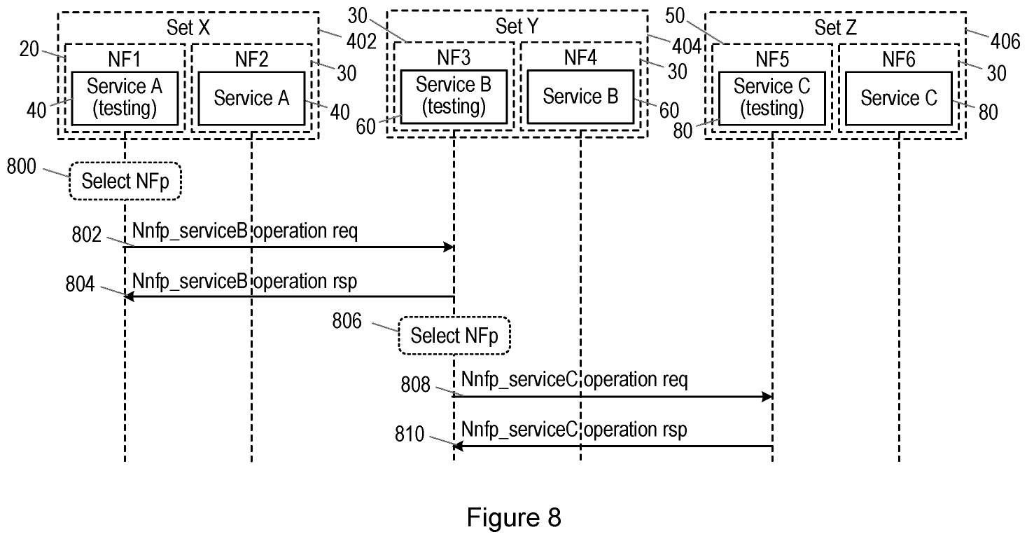

FIG. 8 is a signalling diagram illustrating an exchange of signals in a system according to an embodiment. The system illustrated in FIG. 8 comprises a plurality of NF nodes 20, 30, 50. The plurality of NF nodes 20, 30, 50 include a first NF node (“NF1”) 20, a second NF node (“NF3”) 30, and a third NF node (“NF5”) 50. In the embodiment illustrated in FIG. 8, the first NF node 20, the second NF node 30, and the third NF node 50 are under testing in the network. For example, they may be newly upgraded, newly introduced into the system, and/or under testing in the network for any other reason.

As illustrated in FIG. 8, the plurality of NF nodes 20, 30, 50 may also comprise one or more other NF nodes (“NF2”, “NF4”, “NF6”). In the embodiment illustrated in FIG. 8, the first NF node 20 acts as an NF node of a first service consumer, the second NF node acts as an NF node of a second service producer but also as an NF node of a first service consumer, and the third NF node 50 acts as an NF node of a second service producer. The first service consumer may be the same service consumer as the second service consumer, or the first service consumer may be a different service consumer from the second service consumer. Similarly, the first service producer may be the same service producer as the second service producer, or the first service producer may be a different service producer from the second service producer.

The system of FIG. 8 illustrates an embodiment where the first network node mentioned earlier is an NF node of a service consumer and the second network node mentioned earlier is an NF node of a service producer. Specifically, the first NF node 20 can be as described earlier with reference to FIGS. 4 and 5, and the second NF node and/or the third NF node 50 can be as described earlier with reference to FIGS. 2 and 3. Although the first network node in the embodiment illustrated in FIG. 8 is a first NF node 20 of a first service consumer, it will be understood that the first network node may instead by a first SCP node according to other embodiments. Thus, the steps of FIG. 8 described in relation to the first NF node 20 will be understood to be steps that can instead be performed by a first SCP node. For example, although not illustrated in FIG. 8, in some embodiments where the first network node is a first SCP node, the system may also comprise the first NF node 20. In embodiments where the system comprises a first SCP node, the first SCP node can be configured to operate as an SCP between the first NF node 20 and any one or more other NF nodes of the plurality of NF nodes 30, 50.

The plurality of NF nodes 20, 30, 50 can each be for providing, e.g. configured to provide, a service. For example, the first NF node 20 can be for providing a first service 40 (“Service A”), the second NF node 30 can be for providing a second service 60 (“Service B”), and the third NF node 50 can be for providing a third service 80 (“Service C”). In some embodiments, as illustrated in FIG. 8, there may also be at least one other NF node for providing the first service 40, at least one other NF node for providing the second service 60, and at least one other NF node for providing the third service 80. Any two or more of the first service 40, the second service 60, and the third service 80 (e.g. all services) may be the same service, or any two or more of the first service 40, the second service 60, and the third service 80 (e.g. all services) may be a different service.

In some embodiments, as illustrated in FIG. 8, the NF nodes may be grouped. That is, the NF nodes may be split into a plurality of groups (or sets) 402, 404, 406. For example, as illustrated in FIG. 8, a first group (or set) 402 of NF nodes (“Set X”) may comprise the first NF node 20 and optionally one or more other NF nodes, a second group (or set) 404 of NF nodes (“Set Y”) may comprise the second NF node 30 and optionally one or more other NF nodes, and a third group (or set) 406 of NF nodes (“Set Z”) may comprise the third NF node 50 and optionally one or more other NF nodes. Although each group of NF nodes 402, 404, 406 are illustrated in FIG. 8 as comprising two NF nodes, it will be understood that each of these groups of NF nodes 402, 404, 406 may comprise a single NF node according to some embodiments or a plurality of (e.g. two, three or more) NF nodes according to other embodiments. Also, although the NF nodes are considered to be deployed in groups (or sets) 402, 404, 406 in the embodiment illustrated in FIG. 8 (e.g. such that one specific NF node 20, 30, 50 in a group 402, 404, 406 may be under testing in the network), this does not always have to be the case. For example, in other embodiments, individual NF nodes can be deployed, or a combination of one or more groups of NF nodes and one or more individual NF nodes can be deployed.

Although a certain number of NF nodes are illustrated in FIG. 8, it will be understood that the system can comprise any other number of (e.g. one or more) NF nodes. Similarly, although three groups (or sets) 402, 404, 406 of NF nodes are illustrated in FIG. 8, it will be understood that the system can comprise any other number of (e.g. one or more) groups of NF nodes. In some embodiments, the NF nodes may be grouped according to the type of NF node. For example, NF nodes of the same type and/or that can provide the same service 40, 60, 80 can be part of the same group 402, 404, 406.

In some embodiments where the system comprises a first SCP node (not illustrated in FIG. 8), the first SCP node and at least one NF node of the plurality of NF nodes 20, 30, 50 may be deployed in independent deployment units. Thus, an SCP node based on independent deployment units is possible, as described in 3GPP TS 23.501 V16.4.0. In other embodiments where the system comprises a first SCP node (not illustrated in FIG. 8), the first SCP node may be deployed as a distributed network element. For example, in some embodiments, part (e.g. a service agent) of the first SCP node may be deployed in the same deployment unit as at least one NF node of the plurality of NF nodes 20, 30, 50. Thus, an SCP node based on a service mesh is possible, as described in 3GPP TS 23.501 V16.4.0.

In some embodiments (not illustrated in FIG. 8), at least one second SCP node may be configured to operate as an SCP between the first SCP node and at least one NF node of the plurality of NF nodes 20, 30, 50. Thus, a multipath of SCP nodes is possible. In some of these embodiments, the first SCP node and one or more of the at least one second SCP node may be deployed in independent deployment units. In some embodiments, the first SCP node and one or more of the at least one second SCP node may be deployed as distributed network elements.

The method illustrated by FIG. 8 can be performed following (e.g. in response to) the method described earlier with reference to FIGS. 3 and 5. In more detail and although not illustrated in FIG. 8, as described earlier with reference to FIGS. 3 and 5, a second network node (e.g. the second NF node 30 or an NRF node) initiates transmission of a message towards the first NF node 20 (which can be operating as the first network node mentioned earlier) and the first NF node 20 receives the message. The message comprises an indication that an NF node of the plurality of NF nodes is under testing in the network. For the purpose of the embodiment illustrated in FIG. 8, it is assumed that the message comprises an indication that the second NF node 30 is under testing in the network. Thus, the method that follows can be performed following (e.g. in response to) the first NF node 20 receiving the message comprising this indication. The indication signals to the first NF node 20 that the second NF node 30 is a candidate for selection when selecting at least one second NF node of the one or more second NF nodes 30, 50 to provide a service requested by the first NF node 20.

In the embodiment illustrated in FIG. 8, the first NF node 20 is acting as an NF node of a service consumer. As illustrated by arrow 800 of FIG. 8, the first NF node 20 selects at least one other NF node of the plurality of NF nodes to provide (e.g. an instance of) a first service 40 requested by the first NF node 20. In some embodiments, the at least one other NF node can be one or more (e.g. available) NF nodes found during a discovery process, such as that described earlier. The selection is based on the indication. Thus, as the indication signals to the first NF node 20 that the second NF node 30 is a candidate for selection, then the first NF node 20 can select the second NF node 30 to provide the first service 40 in the embodiment illustrated in FIG. 8. For the purpose of illustration, it will be assumed that the second NF node 30 is selected. However, it will be understood that any other NF node of a service producer that the indication signals is a candidate for selection may be selected.

Although not illustrated in FIG. 8, in some embodiments, the first NF node 20 may check one or more attributes of other NF nodes 30, 50 to make the selection. An attribute of an NF node can be indicative of a characteristic of the NF node. For example, a locality attribute of an NF node can be indicative of a locality (or location) of the NF node. Thus, in some embodiments, the first NF node 20 may first check a locality attribute, and/or any other attribute(s) of other NF nodes 30, 50. As such, in some embodiments, the selection of at least one other NF node of the plurality of NF nodes to provide the first service 40 requested by the first NF node 20 may be performed based on one or more attributes of the at least one other NF node.

In some embodiments, a profile of an NF node may comprise the indication and/or one or more attributes for that NF node. For example, an attribute of the one or more attributes for an NF node may be set to the indication (e.g. Locality=“testing”). In some embodiments, the attribute may be a value. Thus, for example, a specific value may be defined to indicate “testing”. The indication may be in any other form, e.g. provided that it is the same indication that is used by all NF nodes. Thus, when an NF node is under testing in the network, it can easily be implemented as such simply by changing an attribute to indicate that it is under testing in the network. In some embodiments, the attribute can be an attribute that is to be (or has to be) prioritised (i.e. taken into account first, and/or always used) when selecting at least one NF node to provide a service requested by an NF node. In this way, it can be ensured that the indication is always taken into account and thus an NF node under testing in the network is selected, such that the testing in the network can be implemented.

In some embodiments, the attribute may be an attribute that matches (i.e. is the same as) or at least partially matches (i.e. is at least partially the same as) a corresponding attribute for the NF node that is requesting the first service 40. Thus, with reference to the embodiment illustrated in FIG. 8, the attribute may be an attribute that matches or at least partially matches a corresponding attribute for the first NF node 20. The first NF node 20 may also be under testing in the network. Thus, when the attribute is set to the indication, the first NF node 20 that is under testing in the network can select the second NF node 30 as it is also under testing in the network. For example, the first NF node 20 may use a certain (e.g. locality) attribute as the first selection criteria to find another NF node that has the same (e.g. locality) attribute. Where this attribute is set to the indication (e.g. “testing”), it means that the first NF node 20 will select an NF node, such as the second NF node 30, that is under testing in the network at the same time. In this case, the selected second NF node 30 is acting as an NF node of a service producer. However, as will be described in more detail later, this selected second NF node 30 may act as a service consumer of another service producer and thus may perform the same steps as the first NF node 20, thereby obtaining an end-to-end path of NF nodes under testing in the network.

As illustrated by arrow 802 of FIG. 8, the first NF node 20 may initiate transmission of (e.g. itself transmit or cause another node to transmit, such as via a communications interface 16 of the first NF node 20) a service request towards the selected second NF node 30. This service request 802 will be referred to herein as the “first service request”. The first NF node 20 may transmit the first service request 802 directly to the selected second NF node 30 or may transmit the first service request 802 indirectly towards the selected second NF node 30 via the first SCP node mentioned earlier and/or any other SCP node (not illustrated in FIG. 8). The selected second NF node 30 receives the first service request 802 (e.g. via a communications interface of the selected second NF node 30). The first service request 802 is a request for the selected second NF node 30 to provide the first service 40 requested by the first NF node 20. The first service 40 may, for example, be requested by the first NF node 20 for a subscriber (e.g. user or user equipment, UE).

As illustrated by arrow 804 of FIG. 8, the selected second NF node 30 may initiate transmission of (e.g. itself transmit or cause another node to transmit, such as via a communications interface of the selected second NF node 30) a first response to the first service request 802 towards the first NF node 20. Thus, the first NF node 20 receives this first response 804 from the second NF node 30 that is selected to provide the first service 40. The first NF node 20 may receive the first response 804 directly from the selected second NF node 30 or may receive the first response 804 indirectly from the selected second NF node 30 via the first SCP node 10 mentioned earlier and/or any other SCP node (not illustrated in FIG. 8). In the embodiment illustrated in FIG. 8, the first request 802 and the second response 804 are between two NF nodes 10, 30 that are under testing in the network (e.g. possibly by different vendors). However, in other embodiments, it may be that only the second NF node 30 of the two NF nodes is under testing in the network.

In some embodiments, such as that illustrated in FIG. 8, the second NF node 30 may itself need to send a request for an NF node to provide a service. For example, the second NF node 30 may need to send a request for an NF node to provide the third service 80. In this case, the second NF node 30 operates as an NF node of a service consumer. As mentioned earlier, the method illustrated by FIG. 8 can be performed following (e.g. in response to) the method described earlier with reference to FIGS. 3 and 5. In more detail and although not illustrated in FIG. 8, as described earlier with reference to FIGS. 3 and 5, a second network node (e.g. the second NF node 50 or an NRF node) initiates transmission of a message towards the second NF node 30 (which can be operating as the first network node mentioned earlier) and the second NF node receives the message. The message comprises an indication that an NF node of the plurality of NF nodes is under testing in the network. For the purpose of the embodiment illustrated in FIG. 8, it is assumed that the message comprises an indication that the third NF node 50 is under testing in the network. Thus, the method that follows can be performed following (e.g. in response to) the second NF node 30 receiving the message comprising this indication. The indication signals to the second NF node 30 that the third NF node 50 is a candidate for selection when selecting at least one second NF node of the one or more second NF nodes 20, 50 to provide a service requested by the second NF node 30.

In the present case, the second NF node 30 is acting as an NF node of a service consumer and the third NF node 50 is acting as an NF node of a service producer. As illustrated by block 806 of FIG. 8, the second NF node 30 selects at least one other NF node of the plurality of NF nodes to provide (e.g. an instance of) a third service 80 requested by the second NF node 30. The selection is based on the indication and, in the embodiment illustrated in FIG. 8, the second NF node 30 selects the third NF node 50 to provide the third service 80 as the indication signalled that it is a candidate for selection. However, it will be understood that any other NF node of a service producer that the indication signals is a candidate for selection may be selected.

Although not illustrated in FIG. 8, in some embodiments, the second NF node 30 may check one or more attributes of other NF nodes 20, 50 to make the selection, such as any of those mentioned earlier. As such, in some embodiments, the selection of at least one other NF node of the plurality of NF nodes to provide the third service 80 requested by the second NF node 30 may be performed based on one or more attributes of the at least one other NF node.

As described earlier, in some embodiments, a profile of an NF node may comprise the indication and/or one or more attributes for that NF node. For example, an attribute of the one or more attributes for an NF node may be set to the indication. In some embodiments, the attribute can be an attribute that is to be prioritised when selecting at least one NF node to provide a service requested by an NF node. In this way, it can be ensured that the indication is always taken into account and thus an NF node under testing in the network is selected, such that the testing in the network can be implemented. In some embodiments, the attribute may be an attribute that matches (i.e. is the same as) or at least partially matches (i.e. is at least partially the same as) a corresponding attribute for the NF node that is requesting the third service 80. Thus, with reference to the embodiment illustrated in FIG. 8, the attribute may be an attribute that matches or at least partially matches a corresponding attribute for the second NF node 30. The second NF node 30 may also be under testing in the network. Thus, when the attribute is set to the indication, the second NF node 30 that is under testing in the network can select the third NF node 50 as it is also under testing in the network.

As illustrated by arrow 808 of FIG. 8, the second NF node 30 may initiate transmission of (e.g. itself transmit or cause another node to transmit, such as via a communications interface 36 of the second NF node 30) a service request towards the selected third NF node 50. This service request 808 will be referred to herein as the “second service request”. The second NF node 30 may transmit the second service request 808 directly to the selected third NF node 50 or may transmit the second service request 808 indirectly towards the selected third NF node 50 via the first SCP node mentioned earlier and/or any other SCP node (not illustrated in FIG. 8). The selected third NF node 50 receives the second service request 808 (e.g. via a communications interface of the selected third NF node 50). The second service request 808 is a request for the selected third NF node 50 to provide the third service 80 requested by the second NF node 30. The third service 80 may, for example, be requested by the second NF node 30 for a subscriber (e.g. user or user equipment, UE).

As illustrated by arrow 810 of FIG. 8, the selected third NF node 50 may initiate transmission of (e.g. itself transmit or cause another node to transmit, such as via a communications interface of the selected third NF node 50) a second response to the second service request 808 towards the second NF node 30. Thus, the second NF node receives this second response 810 from the third NF node 50 that is selected to provide the third service 80. The second NF node 30 may receive the second response 810 directly from the selected third NF node 50 or may receive the second response 810 indirectly from the selected third NF node 50 via the first SCP node 10 mentioned earlier and/or any other SCP node (not illustrated in FIG. 8). In the embodiment illustrated in FIG. 8, the second request 808 and the second response 810 are between two NF nodes 30, 50 (e.g. possibly by different vendors). However, in other embodiments, it may be that only the third NF node 50 of the two NF nodes is under testing in the network according to other embodiments.

Although not illustrated in FIG. 8, the method may be repeated any one or more times, e.g. by the same NF nodes and/or by other NF nodes, such as each time an NF node needs to send network traffic (e.g. another service request) to another NF node. In the manner described with reference to FIG. 8, NF nodes advantageously have knowledge of which other NF node to select so as to ensure that NF nodes under testing in the network receive the necessary network traffic to be able to undergo that testing in the network. Thus, end-to-end testing in the network is made possible. Moreover, the method allows upgraded or newly introduced NF nodes (or instances of NF nodes) to be tested in the network, e.g. for different NF types and/or from different vendors, without affecting the rest of the network and without requiring any specific configuration changes for its implementation.

Although the method illustrated in FIG. 8 is described with reference to a service request, it will be understood that the method can be applied to any other network traffic. As mentioned earlier, the network traffic referred to herein can be any type of network traffic, e.g. any network traffic that is to be transmitted by the first network node (e.g. the first NF node 10, the second NF node 30, or the first SCP node) towards one or more NF nodes of one or more service producers (e.g. the second NF node 30, or the third NF node 50). For example, the network traffic can comprise one or more requests for a service 40, 60, 80 to be provided by one or more NF nodes 20, 30, 50, one or more other requests, data associated with one or more of these request(s), and/or any other data.

Although the techniques have been described herein with reference to a selection of a second NF node 30, 50, it will be understood that the techniques can also apply to the reselection of a second NF node 30, 50 (e.g. following a failure in relation to a previously selected second NF node).

Other embodiments include those defined in the following numbered statements:

Embodiment 1. A method for handling messages in a fifth generation network, wherein the method is performed by a first network node (10, 20), wherein the first network node (10, 20) is a first network function, NF, node (20) of a service consumer or a first service communication proxy, SCP, node (10) that is configured to operate as an SCP between the first NF node (20) and one or more second NF nodes (30, 50) of a service producer, the method comprising:
receiving (102, 610, 704) a message from a second network node (30, 60), wherein the message comprises:
   an indication that a second NF node (30) of the one or more second NF nodes (30, 50) is under testing in the network; and
   wherein the indication signals to the first network node (10, 20) that the second NF node (30) is a candidate for selection when selecting at least one second NF node (30) of the one or more second NF nodes (30, 50) towards which network traffic is to be transmitted; and/or
   the message comprises load information for the second NF node (30) and the indication signals to the first network node (10, 20) that the load information is representative of a predefined amount of network traffic that the second NF node (30) is required to receive.

Embodiment 2. A method according to Embodiment 1, wherein:
the second network node (30, 60) is:
   the second NF node (30); or
   a network repository function node (60).

Embodiment 3. A method according to Embodiment 1 or 2, wherein:
a profile of the second NF node (30) comprises the indication and/or the load information.

Embodiment 4. A method according to Embodiment 3, wherein:
the profile comprises one or more attributes for the second NF node (30); and
an attribute of the one or more attributes for the second NF node (30) is set to the indication.

Embodiment 5. A method according to Embodiment 4, wherein:
the attribute is a locality attribute indicative of a location of the second NF node (30).

Embodiment 6. A method according to Embodiment 4 or 5, wherein:
the attribute is an attribute that is to be prioritised when selecting the at least one second NF node (30).

Embodiment 7. A method according to any of Embodiments 4 to 6, wherein:
the attribute is an attribute that matches or at least partially matches a corresponding attribute for the first NF node (20).

Embodiment 8. A method according to any of Embodiments 3 to 7 when Embodiment 3 is dependent on Embodiment 2, wherein:
the second network node is the network repository function node (60); and
the message comprises the profile of the second NF node (30).

Embodiment 9. A method according to Embodiment 8, wherein:
the message is received in response to:
   a change to the load information; and/or
   a discovery request, wherein the discovery request is a request for information indicative of one or more second NF nodes (30, 50) for providing a service requested by the first NF node (20).

Embodiment 10. A method according to Embodiment 9, wherein:
the first network node (10, 20) is subscribed to be notified of the change.

Embodiment 11. A method according to Embodiment 2, or any of Embodiments 3 to 7 when Embodiment 3 is dependent on Embodiment 2, wherein:
the second network node is the second NF node (30); and
the message is a response to a service request, wherein the service request is a request for the second NF node (30) to provide a service (40) requested by the first NF node (20).

Embodiment 12. A method according to any of the preceding Embodiments, wherein:
the message comprises a load control information, LCI, header and the LCI header comprises the indication.

Embodiment 13. A method according to any of the preceding Embodiments, wherein:
the first NF node (20) is under testing in the network.

Embodiment 14. A method according to any of the preceding Embodiments, the method comprising:
selecting at least one second NF node (30) of the one or more second NF nodes (30, 50) towards which network traffic is to be transmitted, wherein the selection is based on the indication.

Embodiment 15. A method according to any of the preceding Embodiments, wherein:
the selecting of at least one second NF node (30) of the one or more second NF nodes is for the at least one second NF node (30) to provide a service (40) requested by the first NF node (20); and/or
the network traffic comprises a service request, wherein the service request is a request for the service (40) requested by the first NF node (20) to be provided.

Embodiment 16. A method according to any of the preceding Embodiments, wherein:
the predefined amount of network traffic that the second NF node (30) is required to receive is a predefined percentage of a total amount of network traffic available for transmission.

Embodiment 17. A method according to any of the preceding Embodiments, the method comprising:
initiating transmission of the predefined amount of network traffic that the second NF node (30) is required to receive towards the second NF node (30).

Embodiment 18. A method according to Embodiment 17, the method comprising:
initiating transmission of a remaining amount of network traffic available for transmission towards at least one other second NF node of the one or more second NF nodes.

Embodiment 19. A method according to Embodiment 18, wherein:
transmission of the remaining amount of network traffic is initiated towards at least two other second NF nodes of the one or more second NF nodes and the network traffic is distributed among the at least two other second NF nodes to balance a load on the at least two other second NF nodes.

Embodiment 20. A method according to any of the preceding Embodiments, wherein:
the first SCP node (10) and the first NF node (20) are deployed in independent deployment units; and/or
the first SCP node (10) and the second NF node (30) are deployed in independent deployment units.

Embodiment 21. A method according to any of Embodiments 1 to 19, wherein:
the first SCP node (10) is deployed as a distributed network element.

Embodiment 22. A method according to Embodiment 21, wherein:
part of the first SCP node (10) is deployed in the same deployment unit as the first NF node (20); and/or
part of the first SCP node (10) is deployed in the same deployment unit as the second NF node (30).

Embodiment 23. A method according to any of the preceding Embodiments, wherein:
at least one second SCP node is configured to operate as an SCP between the first NF node (20) and the first SCP node (10); and/or
at least one third SCP node is configured to operate as an SCP between the first SCP node (10) and the second NF node (30).

Embodiment 24. A method according to Embodiment 23, wherein:
the first SCP node (10) and one or more of the at least one second SCP node and the at least one third SCP node are deployed in independent deployment units.

Embodiment 25. A method according to Embodiment 23, wherein:
the at least one second SCP node and/or the at least one third SCP node are deployed as distributed network elements.

Embodiment 26. A method according to any of the preceding Embodiments, wherein:
an entity comprises the first SCP node (10) and a network repository function, NRF, node (60).

Embodiment 27. A first network node (10, 20) comprising:
processing circuitry (12) configured to operate in accordance with any of Embodiments 1 to 26.

Embodiment 28. A first network node (10, 20) according to Embodiment 27, wherein:
the first network node (10, 20) comprises:
   at least one memory (14) for storing instructions which, when executed by the processing circuitry (12), cause the first network node (10, 20) to operate in accordance with any of Embodiments 1 to 26.

Embodiment 29. A method for handling messages in a fifth generation network, wherein the method is performed by a second network node (30, 60), the method comprising:
initiating (302, 610, 704) transmission of a message towards a first network node (10, 20), wherein the first network node (10, 20) is a first network function, NF, node (20) of a service consumer or a first service communication proxy, SCP, node (10) that is configured to operate as an SCP between the first NF node (20) and one or more second NF nodes of a service producer, and
wherein the message comprises:
   an indication that a second NF node (30) of the one or more second NF nodes (30, 50) is under testing in the network; and
   wherein the indication signals to the first network node (10, 20) that the second NF node (30) is a candidate for selection when selecting at least one second NF node (30) of the one or more second NF nodes (30, 50) towards which network traffic is to be transmitted; and/or
   the message comprises load information for the second NF node (30) and the indication signals to the first network node (10, 20) that the load information is representative of a predefined amount of network traffic that the second NF node (30) is required to receive.

Embodiment 30. A method according to Embodiment 29, wherein:
the second network node (30, 60) is:
   the second NF node (30); or
   a network repository function node (60).

Embodiment 31. A method according to Embodiment 29 or 30, wherein:
a profile of the second NF node (30) comprises the indication and/or load information.

Embodiment 32. A method according to Embodiment 31, wherein:
the profile comprises one or more attributes for the second NF node (30); and
an attribute of the one or more attributes for the second NF node (30) is set to the indication.

Embodiment 33. A method according to Embodiment 32, the method comprising:
setting the attribute to the indication.

Embodiment 34. A method according to Embodiment 32 or 33, wherein:
the attribute is a locality attribute indicative of a location of the second NF node (30).

Embodiment 35. A method according to any of Embodiments 32 to 34, wherein:
the attribute is an attribute that is to be prioritised when selecting the at least one second NF node (30).

Embodiment 36. A method according to any of Embodiments 32 to 35, wherein:
the attribute is an attribute that matches or at least partially matches a corresponding attribute for the first NF node (20).

Embodiment 37. A method according to any of Embodiments 31 to 36 when Embodiment 31 is dependent on Embodiment 30, wherein:
the second network node is the network repository function node (60); and
the message comprises the profile of the second NF node (30).

Embodiment 38. A method according to Embodiment 37, wherein:
transmission of the message is initiated in response to:
   a change to the load information; and/or
   a discovery request, wherein the discovery request is a request for information indicative of one or more second NF nodes (30, 50) for providing a service requested by the first NF node (20).

Embodiment 39. A method according to Embodiment 38, wherein:
the first network node (10, 20) is subscribed to be notified of the change.

Embodiment 40. A method according to Embodiment 30, or any of Embodiments 31 to 36 when Embodiment 31 is dependent on Embodiment 30, wherein:
the second network node is the second NF node (30); and
the message is a response to a service request, wherein the service request is a request for the second NF node (30) to provide a service (40) requested by the first NF node (20).

Embodiment 41. A method according to any of Embodiments 29 to 40, wherein:
the message comprises a load control information, LCI, header and the LCI header comprises the indication.

Embodiment 42. A method according to any of Embodiments 29 to 41, wherein:
the first NF node (20) is under testing in the network.

Embodiment 43. A method according to any of Embodiments 29 to 42, wherein:
the selecting of at least one second NF node (30) of the one or more second NF nodes is for the at least one second NF node (30) to provide a service (40) requested by the first NF node (20); and/or
the network traffic comprises a service request, wherein the service request is a request for the service (40) requested by the first NF node (20) to be provided.

Embodiment 44. A method according to any of Embodiments 29 to 43, wherein:
the predefined amount of network traffic that the second NF node (30) is required to receive is a predefined percentage of a total amount of network traffic available for transmission.

Embodiment 45. A method according to any of Embodiments 29 to 44, wherein:
the first SCP node (10) and the first NF node (20) are deployed in independent deployment units; and/or
the first SCP node (10) and the second NF node (30) are deployed in independent deployment units.

Embodiment 46. A method according to any of Embodiments 29 to 44, wherein:
the first SCP node (10) is deployed as a distributed network element.

Embodiment 47. A method according to Embodiment 46, wherein:
part of the first SCP node (10) is deployed in the same deployment unit as the first NF node (20); and/or
part of the first SCP node (10) is deployed in the same deployment unit as the second NF node (30).

Embodiment 48. A method according to any of Embodiments 29 to 47, wherein:
at least one second SCP node is configured to operate as an SCP between the first NF node (20) and the first SCP node (10); and/or
at least one third SCP node is configured to operate as an SCP between the first SCP node (10) and the second NF node (30).

Embodiment 49. A method according to Embodiment 48, wherein:
the first SCP node (10) and one or more of the at least one second SCP node and the at least one third SCP node are deployed in independent deployment units.

Embodiment 50. A method according to Embodiment 48, wherein:
the at least one second SCP node and/or the at least one third SCP node are deployed as distributed network elements.

Embodiment 51. A method according to any of Embodiments 29 to 50, wherein:
an entity comprises the first SCP node (10) and a network repository function,
NRF, node (60).

Embodiment 52. A second network node (30, 60), the second network node (30, 60) comprising:
processing circuitry (32) configured to operate in accordance with any of Embodiments 29 to 51.

Embodiment 53. A second network node (30, 60) according to Embodiment 52, wherein:
the second network node (30, 60) comprises:
   at least one memory (34) for storing instructions which, when executed by the processing circuitry (32), cause the second network node (30, 60) to operate in accordance with any of Embodiments 29 to 51.

Embodiment 54. A method performed by a system, the method comprising:
the method according to any of Embodiments 1 to 26; and
the method according to any of Embodiments 29 to 51.

Embodiment 55. A system comprising:
at least one first network node (10, 20) according to Embodiment 27 or 28; and
at least one second network node (30, 60) according to Embodiment 52 or 53.

Embodiment 56. A computer program comprising instructions which, when executed by processing circuitry, cause the processing circuitry to perform the method according to any of Embodiments 1 to 26 and/or any of Embodiments 29 to 51.

Embodiment 57. A computer program product, embodied on a non-transitory machine-readable medium, comprising instructions which are executable by processing circuitry to cause the processing circuitry to perform the method according to any of Embodiments 1 to 26 and/or any of Embodiments 29 to 51.

There is also provided a computer program comprising instructions which, when executed by processing circuitry (such as the processing circuitry 12 of the first network node 10, 20 described earlier and/or the processing circuitry 32 of the second network node 30, 60 described earlier), cause the processing circuitry to perform at least part of the method described herein. There is provided a computer program product, embodied on a non-transitory machine-readable medium, comprising instructions which are executable by processing circuitry (such as the processing circuitry 12 of the first network node 10, 20 described earlier and/or the processing circuitry 32 of the second network node 30, 60 described earlier) to cause the processing circuitry to perform at least part of the method described herein. There is provided a computer program product comprising a carrier containing instructions for causing processing circuitry (such as the processing circuitry 12 of the first network node 10, 20 described earlier and/or the processing circuitry 32 of the second network node 30, 60 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the first network node functionality and/or the second network node functionality described herein can be performed by hardware. Thus, in some embodiments, any one or more of the first network node 10, 20 and the second network node 30, 60 described herein can be a hardware node. However, it will also be understood that optionally at least part or all of the first network node functionality and/or the second network node functionality described herein can be virtualized. For example, the functions performed by any one or more of the first network node 10, 20 and the second network node 30, 60 described herein can be implemented in software running on generic hardware that is configured to orchestrate the node functionality. Thus, in some embodiments, any one or more of the first network node 10, 20 and the second network node 30, 60 described herein can be a virtual node. In some embodiments, at least part or all of the first network node functionality and/or the second network node functionality described herein may be performed in a network enabled cloud. The first network node functionality and/or the second network node functionality described herein may all be at the same location or at least some of the node functionality may be distributed.

It will be understood that at least some or all of the method steps described herein can be automated in some embodiments. That is, in some embodiments, at least some or all of the method steps described herein can be performed automatically. The method described herein can be a computer-implemented method.

Thus, in the manner described herein, there are advantageously provided improved techniques for handling messages in a fifth generation network. The techniques can provide a mechanism to support testing (e.g. canary testing) in the network at one or more NF nodes 30, 50 of one or more service producers.

For example, the techniques allow one or more NF nodes 30, 50 of one or more service producers to be tested in the network when newly introduced into the network and/or upgraded (e.g. with new software and/or features). The techniques enable an end-to-end signalling path in a network of (e.g. isolated) NF nodes under testing in the network, which does not affect the rest of the NF nodes. It is possible (e.g. for different vendors) to test the interaction between NF nodes in the network, such as those that have not been tested in a lab prior to inclusion in the network and/or those that have not previously been tested in the network. This can be particularly beneficial as it is usually the case that new NF nodes and/or (e.g. software) upgrades to existing NF nodes need to be introduced into the network in a controlled way, so as to allow them to be tested in the network prior to being included fully in the network. For example, new upgrades may be tested on a single NF node of a service producer in the network, before the upgrades are considered for all NF nodes of the service producer in the network.

The techniques are also advantageously compatible with existing load control mechanisms. Moreover, the techniques do not require any specific configuration (or modification) at the first network node 10, 20, since they allow the second NF node 30 to itself indicate (e.g. in its profile) an expected behaviour. The first network node 10, 20 is able to identify which second NF nodes 30, 50 require network traffic (e.g. due to them being under testing in the network) and/or what amount of network traffic needs to be transmitted towards them.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-32. (canceled)

33. A method performed by a first network node for handling messages in a fifth generation (5G) network that includes a first network function (NF) node of a consumer for a service and one or more second NF nodes of a producer for the service, the method comprising:
receiving, from a second network node, a message including an indication that a second NF node of the one or more second NF nodes is under testing in the network, wherein indication further indicates one or more of the following:
that the second NF node is a candidate for selection when selecting at least one second NF node of the one or more second NF nodes towards which network traffic is to be transmitted; and
when the message includes load information for the second NF node, that the load information is representative of a predefined amount of network traffic that the second NF node is required to receive,
wherein the first network node is the first NF node or a first service communication proxy (SCP) node configured to operate as an SCP between the first NF node and the one or more second NF nodes.

34. The method of claim 33, wherein:
the message includes a profile of the second NF node,
the indication is included in the profile, and
when the message includes the load information, the load information is included in the profile.

35. The method of claim 34, wherein the profile comprises one or more attributes for the second NF node, and one of the attributes is set to the indication.

36. The method of claim 35, wherein the attribute set to the indication is one or more of the following:
a locality attribute indicative of a location of the second NF node;
an attribute to be prioritized when selecting the at least one second NF node; and
an attribute that at least partially matches a corresponding attribute for the first NF node.

37. The method of claim 34, wherein:
the second network node is a network repository function (NRF) node; and
the message is received in response to one or more of the following:
a change to the load information; and
a discovery request for information indicative of producers of a service requested by the first NF node.

38. The method of claim 34, wherein the second network node is the second NF node, and the message is a response to a service request for the second NF node to provide a service requested by the first NF node.

39. The method of claim 33, wherein the message includes a load control information (LCI) header, which includes the indication.

40. The method of claim 33, further comprising selecting, based on the indication, at least one of the one or more second NF nodes towards which network traffic is to be transmitted.

41. The method of claim 33, wherein one or more of the following applies:
selecting the at least one second NF node is for the at least one second NF node to provide a service requested by the first NF node; and
the network traffic comprises a service request for provision of the service requested by the first NF node.

42. The method of claim 33, wherein the predefined amount of network traffic that the second NF node is required to receive is a predefined percentage of a total amount of network traffic available for transmission.

43. The method of claim 33, further comprising initiating transmission, towards the second NF node, of the predefined amount of network traffic that the second NF node is required to receive.

44. The method of claim 43, wherein the one or more second NF nodes include a plurality of second NF nodes, and the method further comprising initiating transmission, towards at least one other of the plurality of second NF nodes, of a remaining amount of network traffic available for transmission.

45. The method of claim 44, wherein transmission of the remaining amount of network traffic is initiated towards at least two other of the plurality of second NF nodes with a distribution that balances load on the at least two other second NF nodes.

46. A first network node comprising processing circuitry configured to perform the method of claim 33.

47. A method performed by a second network node for handling messages in a fifth generation (5G) network that includes a first network function (NF) node of a consumer for a service and one or more second NF nodes of a producer for the service, the method comprising:
initiating transmission, towards a first network node, of a message including an indication that a second NF node of the one or more second NF nodes is under testing in the network, wherein indication further indicates one or more of the following:
that the second NF node is a candidate for selection when selecting at least one second NF node of the one or more second NF nodes towards which network traffic is to be transmitted; and
when the message includes load information for the second NF node, that the load information is representative of a predefined amount of network traffic that the second NF node is required to receive,
wherein the first network node is the first NF node or a first service communication proxy (SCP) node configured to operate as an SCP between the first NF node and the one or more second NF nodes.

48. The method of claim 47, wherein:
the message includes a profile of the second NF node,
the indication is included in the profile, and
when the message includes the load information, the load information is included in the profile.

49. The method of claim 48, wherein the profile comprises one or more attributes for the second NF node, and one of the attributes is set to the indication.

50. The method of claim 49, wherein the attribute set to the indication is one or more of the following:
a locality attribute indicative of a location of the second NF node;
an attribute to be prioritized when selecting the at least one second NF node; and
an attribute that at least partially matches a corresponding attribute for the first NF node.

51. The method of claim 48, wherein:
the second network node is a network repository function (NRF) node; and
transmission of the message is initiated in response to one or more of the following:
a change to the load information; and
a discovery request for information indicative of producers of a service requested by the first NF node.

52. The method of claim 48, wherein the second network node is the second NF node, and the message is a response to a service request for the second NF node to provide a service requested by the first NF node.

53. The method of claim 47, wherein the message includes a load control information (LCI) header, which includes the indication.

54. The method of claim 47, wherein the network traffic comprises a service request for provision of the service requested by the first NF node.

55. The method of claim 47, wherein the predefined amount of network traffic that the second NF node is required to receive is a predefined percentage of a total amount of network traffic available for transmission.

56. A second network node comprising processing circuitry configured to perform the method of claim 47.
